(19) United States
(12) Patent Application Publication
(10) Pub. No.: US 2004/0149790 A1
(43) Pub. Date: Aug. 5, 2004

(54) Baby carrier

(75) Inventors: Kenzou Kassai, Osaka (JP); Ichiro Onishi, Osaka (JP); Koichi Yokoyama, Osaka (JP); Yoko Onishi, Osaka (JP)

Correspondence Address: FASSE PATENT ATTORNEYS, P.A., P.O. BOX 726, HAMPDEN, ME, 04444-0726, US

(73) Assignee: Aprica Kassai Kabushikikaisha, Osaka (JP)

(21) Appl. No.: 10/407,616

(22) Filed: Apr. 4, 2003

(30) Foreign Application Priority Data
Feb. 4, 2003 (JP) 2003-027042

(51) Int. Cl. A61G 1/00; A61G 5/00

(52) U.S. Cl. 224/160; 224/158

(57) ABSTRACT

Between a user wear member and a baby holding member of a baby carrier, provided are: first connection means for enabling lateral hold of a baby that is laid down, using the baby holding member on the front side of a mother; second connection means for enabling front side vertical hold of the baby in an upright posture, using the baby holding member on the front side of the mother; and third connection means for enabling back side vertical hold of the baby in an upright posture, using the baby holding member on the back of the mother. In this manner, the baby carrier with a structure implementing lateral hold, i.e. a state in which a newborn or a baby of which neck or lower body is not stable is held laid-down, front side vertical hold, and back side vertical hold, can be provided.

### BACKGROUND OF THE INVENTION

1. Field of the Invention

The present invention relates to a structure of a baby carrier used in child rearing.

2. Description of the Background Art

One example of a conventional baby carrier with a structure allowing change between a front side support and a back side support of a baby is disclosed in Japanese Patent Laying-Open No. 9-121987. The baby carrier is characterized in that a baby carrier body is detachable from a support portion formed with a belt member and worn by a user.

On the other hand, in the structure of the above-mentioned baby carrier, the support portion worn by the user is formed only with the belt member. Accordingly, the weight of the baby accommodated in the baby carrier body locally concentrates, which imposes a significant load on the user.

In addition, as a head region of the baby is not protected, protection of the baby's head is not sufficient particularly when the baby is held on a back of the user.

Moreover, what is assumed is that the baby is held vertically, whether the baby is supported on the front side or the back side. A newborn baby or a baby of which neck or lower body is not stable cannot be held in a laid-down manner.

### SUMMARY OF THE INVENTION

The present invention was made to solve the above-mentioned problems. An object of the present invention is to provide a baby carrier with a structure enabling what is called “lateral hold”, that is, holding a neonatal or a baby of which neck or lower body is not stable in a laid-down manner, as well as attaining sufficient protection of a baby's head.

Another object of the present invention is to provide a baby carrier capable of satisfying baby's essential needs during its growing stage, and having a form variable in accordance with its lifestyle.

Another object of the present invention is to provide a baby carrier capable of improving performance in wearing for the user without impairing safety and comfortability in holding a baby.

Another object of the present invention is to provide a baby carrier with a structure mitigating load on the user by bearing the load in a well-balanced manner on the front side and the back side.

Another object of the present invention is to provide a baby carrier attaining higher fashionability by incorporating a function as a baby carrier into a casual garment.

According to one aspect of a baby carrier of the present invention, a baby carrier used for holding a baby by a user includes a user wear member worn by the user, and a baby holding member for holding the baby along with the user wear member, which is detachable from the user wear member. Between the user wear member and the baby holding member, provided are: a first connection portion for enabling lateral hold of the baby that is laid down, using the baby holding member on a front side of the user; a second connection portion for enabling front side vertical hold of the baby in an upright posture, using the baby holding member on the front side of the user; and a third connection portion for enabling back side vertical hold of the baby in an upright posture, using the baby holding member on the back side of the user.

With such a structure, the baby carrier can be used in lateral hold, front side vertical hold, and back side vertical hold. Therefore, the baby carrier can be used from a neonatal period.

In the present invention, preferably, the user wear member includes a back pad member for a user (hereinafter, referred to as a “user back pad member”) arranged on a back of the user, and a shoulder belt provided to extend forward from an upper end portion of the user back pad member so that the user can wear the user back pad member.

With such a structure, the weight of the baby can be born on the overall user back pad member, and the weight of the baby imposed on the user can be distributed on the entire back. Accordingly, fatigue of the user is mitigated, and use feeling of the baby carrier can be improved.

In the present invention, more preferably, the user back pad member includes a core material. Accordingly, particularly in a back side vertical hold state, the weight of the baby imposed on the user can effectively be distributed on the entire back.

In the present invention, preferably, the user wear member further includes a waist belt worn around a waist of the user. Thus, the user wear member can be worn by the user in a more stable manner, and the weight of the baby can be distributed also on the waist region.

In the present invention, preferably, the waist belt includes a guide portion for guiding the user back pad member with respect to the waist belt in a manner allowing upward and downward movement. In addition, preferably, the guide portion includes a sack portion storing the lower end region of the user back pad member so as to allow upward and downward movement of the user back pad member. Moreover, preferably, a connection portion for connecting the user back pad member to the waist belt is provided therebetween.

With such a structure, the user back pad member can expand and contract with respect to the waist belt. Therefore, the user back pad member can adaptively be positioned in accordance with a body shape of the user.

In the present invention, preferably, the shoulder belt is provided in a pair on left and right sides. The baby holding portion includes a band shaped holding member holding a head portion, an upper body portion, and a lower body portion of the baby. The first connection portion includes an upper portion connection portion in lateral hold (hereinafter, referred to as a “lateral hold upper portion connection portion”) for detachably connecting vicinity areas of an upper end portion on the left and right sides of the holding member to respective one of the should belt pair, and a lower portion connection portion in lateral hold (hereinafter, referred to as a “lateral hold lower portion connection portion”) for detachably connecting a lower end portion of the holding member to either one of the should belt pair. With such a structure, the baby can be held laterally, and a newborn or a baby of which neck and lower body are not stable can be held in a laid-down manner.

In the present invention, more preferably, a cushion member is provided on an inner face side of the lateral hold upper portion connection portion. With such a structure, even if the inner face side of the lateral hold upper portion connection portion abuts the baby, discomfort to the baby can be avoided.

In the present invention, more preferably, the holding member includes a pad member for a baby (hereinafter, referred to as a “baby pad member”) being in contact with the head portion, the upper body portion, and the lower body portion of the baby and having a core material inside, as well as a band-shaped support member provided outside the baby pad member, arranged from a head region as far as a lower body region of the baby, and having the lateral hold lower portion connection portion provided at a lower end. With such a structure, since the baby pad member is provided in a portion in contact with the baby, comfortable space can be provided for the baby. In addition, the band-shaped support member can provide overall support from the back side for the baby, stability in supporting the baby can be improved.

In the present invention, more preferably, a space for inserting a user's hand is provided between the baby pad member located in the upper body portion and the band-shaped support member. By inserting user's hand in this space, the support by the user's hand is achieved in a stable manner, and stability in supporting the baby can further be improved.

In the present invention, more preferably, a band-shaped support member storage region for storing the band-shaped support member is provided on a back side of the holding member. Accordingly, the band-shaped support member can be stored in the band-shaped support member storage region when it is not used, and design in terms of appearance can be improved.

In the present invention, more preferably, the user wear member further includes a waist belt worn around a waist of the user. The shoulder belt is provided in a pair on left and right sides. The baby holding portion includes a holding member holding a head portion, an upper body portion, and a lower body portion of the baby. The second connection portion includes an upper portion connection portion in front side vertical hold (hereinafter, referred to as a “front side vertical hold upper portion connection portion”) for detachably connecting vicinity areas of an upper end portion on the left and right sides of the holding member located in a head region of the baby to respective one of the shoulder belt pair; an intermediate portion connection portion in front side vertical hold (hereinafter, referred to as a “front side vertical hold intermediate portion connection portion”) for detachably connecting intermediate regions on the left and right sides of the holding member located in side regions of the baby to respective one of the shoulder belt pair; and a lower end portion connection portion in front side vertical hold (hereinafter, referred to as a “front side vertical hold lower end portion connection portion”) for detachably connecting a lower end portion of the holding member located in a crotch portion of the baby to the waist belt.

With such a structure, the baby can be held vertically on the front side of the user. In addition, as the front side vertical hold upper portion connection portion is positioned in the side face portion of the baby's head, lateral sway of the baby's head is prevented, and protection of the head and a neck region of the baby can be achieved.

In the present invention, more preferably, a cushion member is provided on an inner face side of the front side vertical hold upper portion connection portion. In addition, in the present invention, more preferably, a cushion member is provided on an inner face side of the front side vertical hold intermediate portion connection portion. With this structure, even if the inner face sides of the front side vertical hold upper portion connection portion and the inner face side of the front side vertical hold intermediate portion connection portion abut the baby, discomfort to the baby can be avoided.

In the present invention, more preferably, a front side vertical hold upper portion connection portion storage region for storing the front side vertical hold upper portion connection portion is provided on a back side of the holding member. In addition, in the present invention, more preferably, a front side vertical hold intermediate portion connection portion storage region for storing the front side vertical hold intermediate portion connection portion is provided on a back side of the holding member. Accordingly, when the front side vertical hold upper portion connection portion or the front side vertical hold intermediate portion connection portion is not used, respective storage regions can store the front side vertical hold upper portion connection portion and the front side vertical hold intermediate portion connection portion. Thus, design in terms of appearance can be improved.

In the present invention, more preferably, in the user wear member, the shoulder belt is provided in a pair on left and right sides. The baby holding portion includes a holding member holding a head portion, an upper body portion, and a lower body portion of the baby. The third connection portion includes an upper portion connection portion in back side vertical hold hereinafter, referred to as a “back side vertical hold upper portion connection portion”) for detachably connecting vicinity areas of an upper end portion on the left and right sides of the holding member located in a head region of the baby to respective one of the shoulder belt pair; an intermediate portion connection portion in back side vertical hold (hereinafter, referred to as a “back side vertical hold intermediate portion connection portion”) for detachably connecting intermediate regions on the left and right sides of the holding member located in side regions of the baby to respective one of the shoulder belt pair; and a lower end portion connection portion in back side vertical hold (hereinafter, referred to as a “back side vertical hold lower end portion connection portion”) for detachably connecting a lower end portion of the holding member located in the crotch portion of the baby to a back face side of the holding member.

With such a structure, the baby can be held vertically on the back side of the user. In addition, as the back side vertical hold upper portion connection portion is positioned on the side face of the baby's head, lateral sway of the baby's head is prevented, and protection of the head and a neck region of the baby can be achieved.

In the present invention, more preferably, a cushion member is provided on an inner face side of the back side vertical hold upper portion connection portion. In addition, in the present invention, more preferably, a cushion member is provided on an inner face side of the back side vertical hold intermediate portion connection portion. With this structure, even if the inner face sides of the back side vertical hold upper connection portion and the inner face side of the back side vertical hold intermediate portion connection portion abut the baby, discomfort to the baby can be avoided.

In the present invention, more preferably, a back side vertical hold upper portion connection portion storage region for storing the back side vertical hold upper portion connection portion is provided on a back side of the holding member. In addition, in the present invention, more preferably, a back side vertical hold intermediate portion connection portion storage region for storing the back side vertical hold intermediate portion connection portion is provided on the back side of the holding member. Accordingly, when the back side vertical hold upper portion connection portion or the back side vertical hold intermediate portion connection portion is not used, respective storage regions can store the back side vertical hold upper portion connection portion and the back side vertical hold intermediate portion connection portion. Thus, design in terms of appearance can be improved.

In the present invention, more preferably, the holding member includes a baby pad member that comes in contact with the head portion, the upper body portion, and the lower body portion of the baby, and having a core material inside. With this structure, the baby can reliably be supported from the back side, and a state of holding the baby can be stable.

In the present invention, more preferably, a band-shaped member is provided outside the baby pad member located in the upper body portion. Moreover, a space for inserting the user's hand is provided by the baby pad member and the band-shaped member, By inserting user's hand in this space, the baby can be supported with the user's hand in a stable manner, and stability in supporting the baby can further be improved.

In the present invention, more preferably, a head region, an upper body region and a lower body region of the baby pad member are separably provided. With this structure, when the baby grows and its neck and lower body are stable, the baby can freely move its upper body by removing the upper body region in vertical hold on the front or back side of the user. Thus, curiosity of the baby can be satisfied.

In the present invention, preferably, the core material for the baby pad member is provided so as to inwardly flex in the lower body region. Accordingly, particularly in holding vertically, the weight of the baby will be shifted to the user side by means of a flexed surface in the lower body region. Consequently, downward tension of the user wear member by the weight of the baby can be mitigated, and the weight of the baby can effectively be born on the entire user back pad member.

In the present invention, more preferably, a curved-face region which is inwardly cut is provided in a region where the crotch portion of the baby abuts, of the baby pad member located in the lower body portion. Accordingly, whether the baby is held in a forward-facing or rearward-facing manner while the baby holding member is attached to the user wear member, the crotch portion of the baby will be allowed a space, and discomfort to the baby can be avoided.

In the present invention, more preferably, an additional pad member is further provided in a region where the crotch portion of the baby abuts, of the baby pad member located in the lower body portion. By providing the additional pad member in this manner, abutment of the pad member to the crotch portion of the baby is mitigated, and discomfort to the baby is avoided. Moreover, whether the baby is held in a forward-facing or rearward-facing manner, discomfort to the baby is avoided.

In the present invention, more preferably, lowermost portion connection portions are provided in positions on left and right sides of a lowermost portion of the holding member, for connection to intermediate regions on left and right sides of the holding members respectively. Thus, a lower abdomen region of the baby can be protected in the lower end region of the holding member.

In addition, by adopting a structure incorporating a function to adjust length for the lowermost portion connection portion, a storage space in accordance with a dimension of a leg opening for the baby can be formed, and the baby can be held in an optimal state.

According to a baby carrier member of the present invention, a baby carrier member used for holding a baby by a user includes a user wear member including an annular region for inserting an arm for attachment to a shoulder portion of the user, and a baby holding member for holding a baby along with the user wear member, which is detachable from the user wear member. Between the user wear member and the baby holding member, provided are: a first connection portion for enabling lateral hold of the baby that is laid down, using the baby holding member on a front side of the user; a second connection portion for enabling front side vertical hold of the baby in an upright posture, using the baby holding member on the front side of the user; and a third connection portion for enabling back side vertical hold of the baby in an upright posture, using the baby holding member on the back side of the user are provided.

With such a structure, the baby carrier can be used in lateral hold, front side vertical hold, and back side vertical bold. Therefore, the baby carrier can be used from a neonatal period.

In the present invention, preferably, the baby carrier member is in a form of a garment including at least front bodice and back bodice. Therefore, fashionability of the baby carrier member is improved, and the baby carrier member can be put on in a more agreeable manner.

According to another aspect of a baby carrier of the present invention, a baby carrier used for holding a baby by a user includes a user wear member worn by the user, a baby holding member for holding the baby along with the user wear member, which is detachable from the user wear member, and components in the following.

The user wear member includes a waist belt arranged in a waist region of the user, having a first connection member on one end, and having a second connection member detachable from the first connection member provided on the other end. The baby holding member includes an abdomen belt arranged in an abdomen region of the baby, having a third connection member detachable from the first connection member provided on one end, and having a fourth connection member detachable from the second connection member provided on the other end.

With such a structure, when the user wear member is connected to the baby holding member, not the waist belt but the abdomen belt of the baby holding member is positioned in the abdomen region of the user. Accordingly, the user is closer to the baby, and intimate contact between the user and the baby can be enhanced. Consequently, the baby can feel the user closer, and baby's essential needs during growing stage can be satisfied.

In addition, as the baby can be held closer to the user, load on the user is mitigated by bearing the load of the baby in a well-balanced manner on the front side and the back side. Moreover, performance of attachment to the user is improved, without impairing safety and comfortability in holding a baby.

Further, a structure of the waist belt of the user wear member is simplified, and the baby carrier with higher fashionability can be provided.

In the present invention, preferably, the waist belt further includes a fifth connection member detachable from the third connection member, and a sixth connection member detachable from the fourth connection member in the waist region on a back side of the user.

With this structure, when the baby is carried on the back as well, load on the user is mitigated by bearing the load of the baby in a well-balanced manner. Moreover, performance of attachment to the user is improved, without impairing safety and comfortability in holding a baby.

In the present invention, preferably, the user wear member includes a first shoulder belt and a second shoulder belt arranged on shoulders of a user. The first shoulder belt includes a seventh connection member, and the second shoulder belt includes an eighth connection member. The baby holding member includes a first connection belt having a ninth connection member detachable from the seventh connection member on one end, a first support loop supporting and allowing passage of the first connection belt and positioned on a side of the baby, a second connection belt having the ninth connection member detachable from the eighth connection member on one end, and a second support loop supporting and allowing passage of the second connection belt and positioned on a side of the baby.

With this structure, the first support loop supported by lie first connection belt and the second support loop supported by the first connection belt are arranged on the side of the baby. Therefore, a wall by the first support loop and the second support loop is formed on the side of the baby, and protection of the side of the baby can be ensured. Consequently, the baby carrier with a structure capable of preventing sway of the head and attaining sufficient protection of the baby's head can be provided.

In the present invention, preferably, the first shoulder belt includes a first loop region for allowing passage of the first connection belt or the second connection belt, and the second shoulder belt includes a second loop region for allowing passage of the first connection belt or the second connection belt.

With this structure, when the baby is carried on the back, load on the user is mitigated by bearing the load of the baby in a well-balanced manner. Moreover, performance of attachment to the user is improved, without impairing safety and comfortability in holding a baby.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a state in which a baby can be held laterally on a front side of a mother, using a baby carrier in a first embodiment according to the present invention.

FIGS. 2 and 3 are first and second views showing a state in which the baby can be held vertically on the front side of the mother, using the baby carrier in the first embodiment according to the present invention.

FIGS. 4 and 5 are first and second views showing a state in which the baby can be held vertically on the back side of the mother, using the baby carrier in the first embodiment according to the present invention.

FIG. 6 is a plan view from an inner face side of a baby holding member.

FIG. 7 is a rear view from an outer face side of the baby holding member.

FIGS. 8 and 9 are first and second cross-sectional views in line VIII-VIII in a direction of an arrow in FIG. 6.

FIG. 10 is a front view showing a state in which a user wear member is spread.

FIG. 11 is a rear view showing a state in which the user wear member is spread.

FIG. 12 is a front view showing a state in which the user wear member is closed.

FIGS. 13 and 14 are first and second cross-sectional views in line XIII-XIII viewed in a direction of an arrow in FIG. 11.

FIG. 15 is a cross-sectional view in line XV-XV in a direction of the arrow in FIG. 11.

FIG. 16 is a plan view from an inner face side of a baby holding member according to another embodiment.

FIG. 17 shows a state in which the baby can be held laterally on the front side of the mother, using a baby carrier in another embodiment.

FIG. 18 shows a state in which a baby can be held laterally on the front side of a mother, using a baby carrier 1B in a second embodiment according to the present invention.

FIGS. 19 and 20 are first and second views showing a state in which baby can be held vertically on the front side of mother, using baby carrier 1B in the second embodiment according to the present invention.

FIGS. 21 and 22 are first and second views showing a state in which baby can be held vertically on the back side of mother, using baby carrier 1B in the second embodiment according to the present invention.

FIG. 23 is a front view showing a state in which a user wear member of baby carrier in the second embodiment according to the present invention is spread.

FIG. 24 is a rear view showing a state in which user wear member of baby carrier in the second embodiment according to the present invention is spread.

FIG. 25 is a front view showing a state in which user wear member of baby carrier in the second embodiment according to the present invention is closed FIG. 26 is a developed view of a belt showing only a belt member of baby carrier in the second embodiment according to the present invention.

FIG. 27 is a plan view from an inner face side of a baby holding member of baby carrier in the second embodiment according to the present invention.

FIG. 28 is a rear view from an outer face side of baby holding member of baby carrier in the second embodiment according to the present invention.

FIGS. 29 and 30 are first and second cross-sectional views in line XXIX-XXIX in a direction of an arrow in FIG. 27.

FIG. 31 is a cross-sectional view schematically showing a front side vertical hold connection state of baby carrier in the second embodiment of the present invention.

### DESCRIPTION OF THE PREFERRED EMBODIMENTS

(First Embodiment)

In the following, a baby carrier 1 in the first embodiment according to the present invention will be described with reference to the figures.

(Characteristic Structure of Baby Carrier 1)

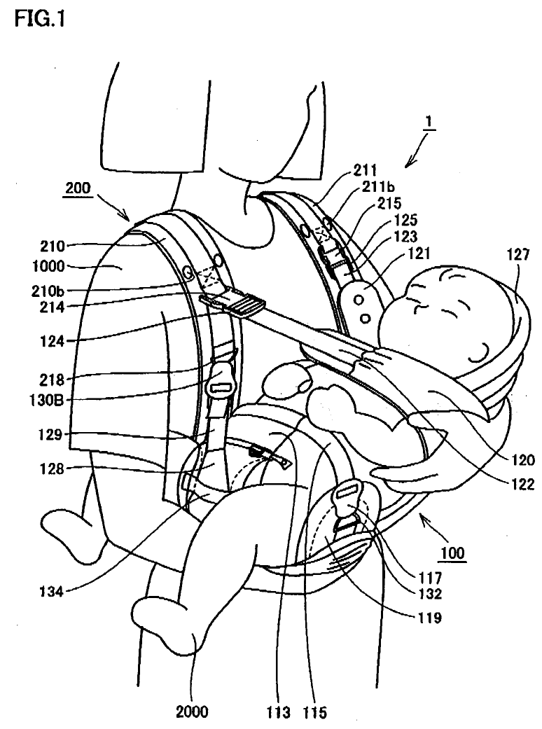

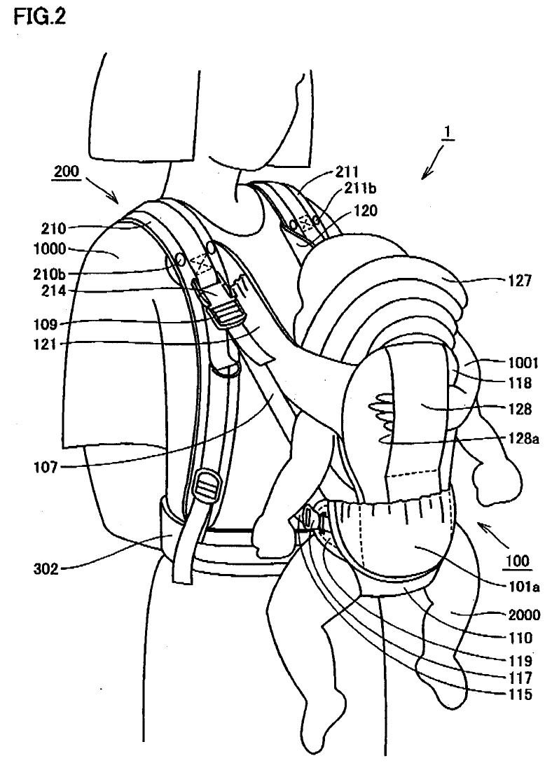

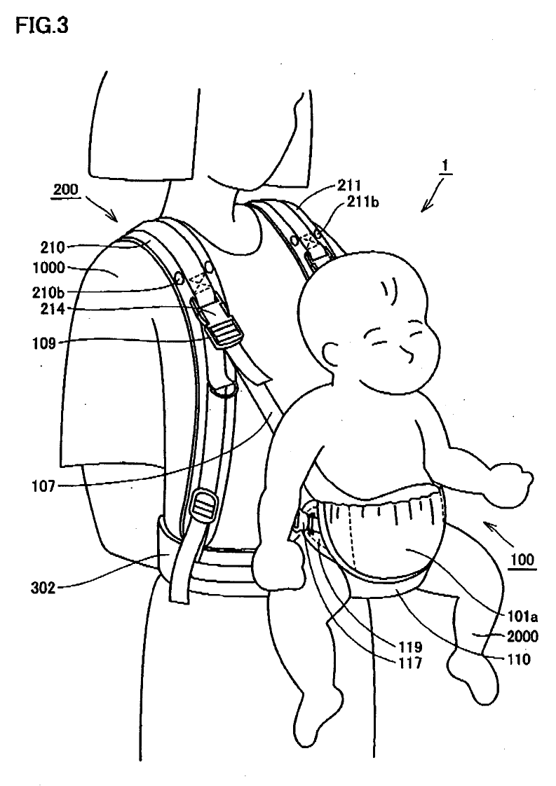

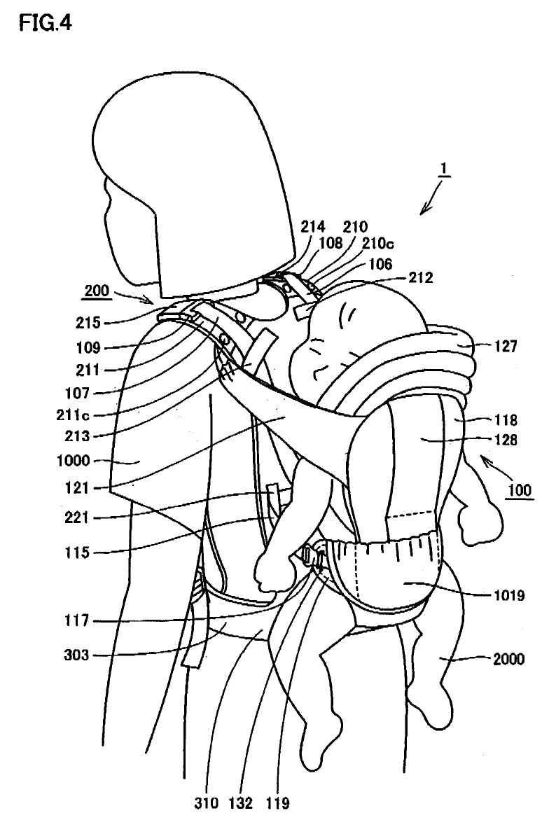

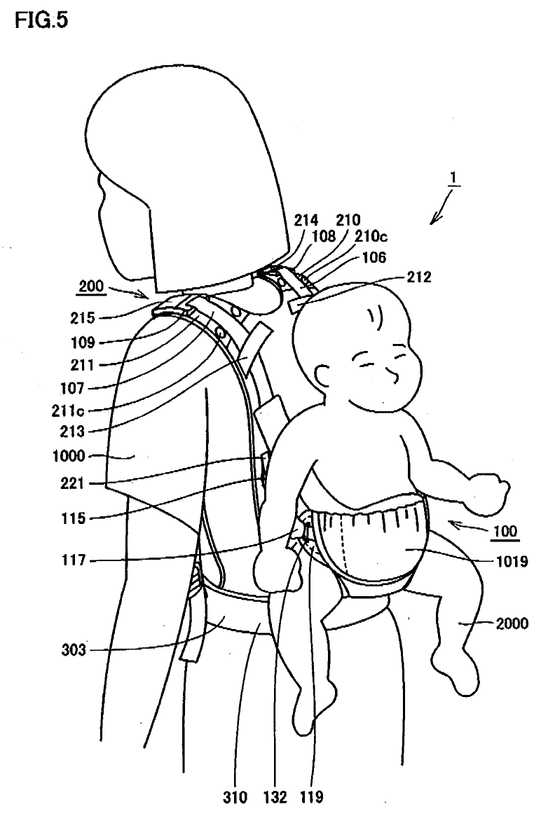

First, baby carrier 1 in the present embodiment is characterized by including a baby holding member 100 and a backpack type user wear member 200, as shown in FIG. 1. Baby carrier 1 is also characterized by selectably providing states in the following. That is, a state in which a baby 2000 can be held laterally on the front side of a mother 1000, who is a user; a state in which baby 2000 can be held vertically on the front side of mother 1000 (facing state), as shown in FIG. 2; a state in which baby 2000 can be held in a forward-facing and vertical manner on the front side of mother 1000 with an upper body region of baby holding member 100 removed, as shown in FIG. 3; a state in which baby 2000 can be held vertically on the back side of mother 1000 (baby 2000 faces forward) as shown in FIG. 4; and a state in which baby 2000 can be held in a rearward-facing and vertical manner on the back side of mother 1000 with the upper body region of baby holding member 100 removed, as shown in FIG. 5.

Here, between baby holding member 100 and user wear member 200, provided are: a first connection portion for enabling lateral hold of baby 2000 that is laid down, using baby holding member 100 on the front side of mother 1000 in the state shown in FIG. 1; a second connection portion for enabling front side vertical hold of baby 2000 in an upright posture, using baby holding member 100 on the front side of mother 1000 in the state shown in FIGS. 2 and 3; and a third connection portion for enabling back side vertical hold of baby 2000 in an upright posture, using baby holding member 100 on the back side of mother 1000 in the state shown in FIGS. 4 and 5.

In the following, initially, structures of baby holding member 100 and user wear member 200 will be described with reference to the figures.

(Structure of Baby Holding Member 100)

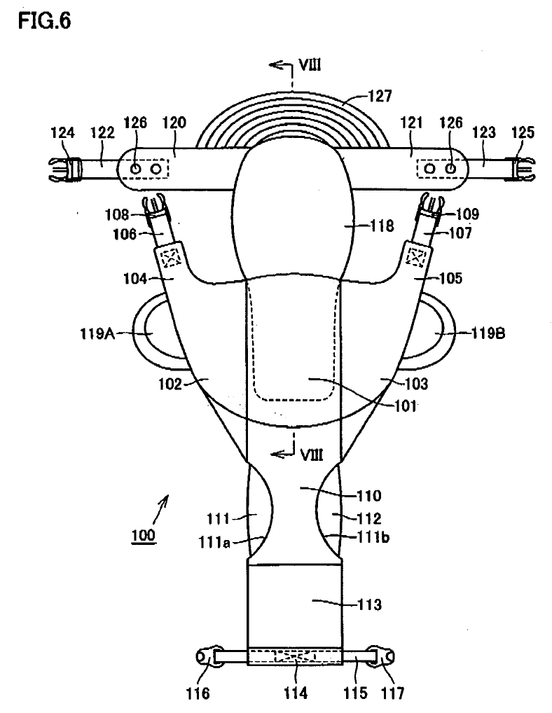

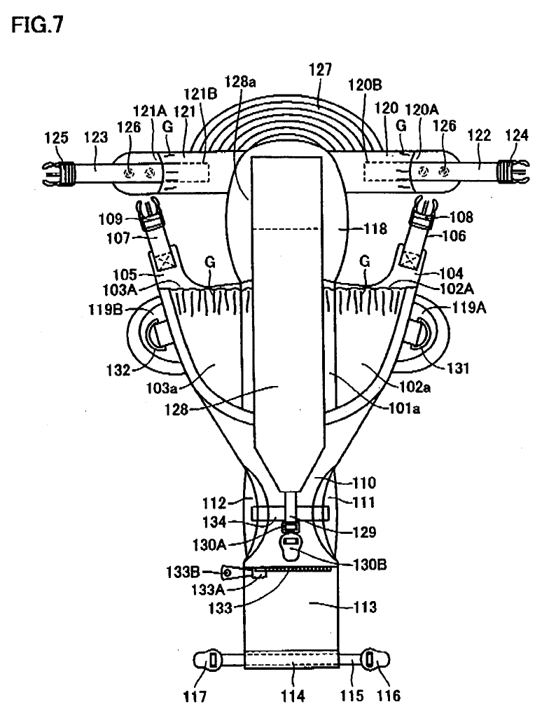

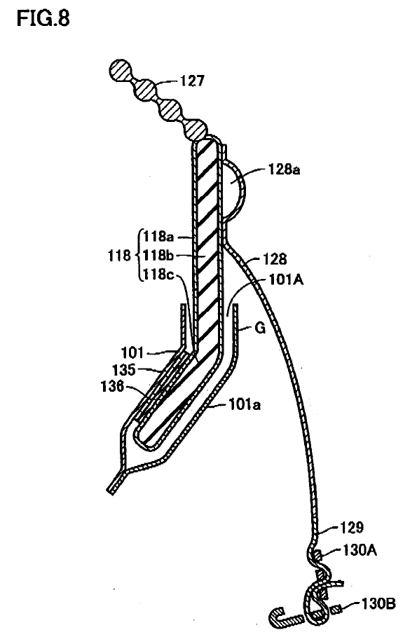

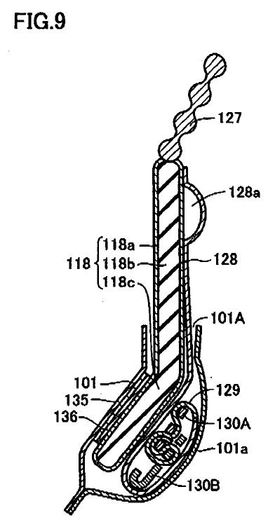

Referring to FIGS. 6 to 9, a structure of baby holding member 100 will be described. FIG. 6 is a plan view from an inner face side of baby holding member 100; FIG. 7 is a rear view from an outer face side of baby holding member 100; FIG. 8 is a first cross-sectional view in line VIII-VIII in a direction of an arrow in FIG. 6; and FIG. 9 is a second cross-sectional view in line VIII-VIII in a direction of the arrow in FIG. 6.

Baby holding member 100 in the present embodiment includes a back face holding member 101, a crotch portion holding member 110, an abdomen portion holding member 113, and a back portion holding member 118. Baby holding member 100 exhibits a longitudinal band shape as a whole.

Referring to FIG. 6, side portion holding members 102, 103 are provided on opposite sides of back face holding member 101. Ear-shaped members 119A, 119B are provided outside side portion holding members 102, 103. Extension portions 104, 105 are provided in respective upper end portions of side portion holding members 102, 103. Belt members 106, 107 are provided in extension portions 104, 105, so as to extend upward. Male buckles 108, 109 capable of adjustment of length of belt members 106, 107 are connected to tip end portions of belt members 106, 107.

Here, inner face portions of back face holding member 101, side portion holding members 102, 103, ear-shaped members 119A, 119B, and extension portions 104, 105 are regions with which baby 2000 comes in contact. Therefore, a breathable cushion member is employed.

Referring to FIG. 7, a sack member 101a is provided on an outer face of back face holding member 110. In addition, sack members 102a, 103a are provided on outer faces of side portion holding members 102, 103 as well. Respective sack members 101a, 102a, 103a are attached so as to have an upward opening, and gather G is provided in upper end portions of sack members 111a, 102a, 103a.

A space 101A formed by back face holding member 101 and sack member 101a can store a band-shaped support member 128, which will be described later. A space 102A formed by side portion holding member 102 and sack member 102a can store extension portion 104, belt member 106, and male buckle 108. A space 103A formed by side portion holding member 103 and sack member 103a can store extension portion 105, belt member 107, and male buckle 109.

In addition, ring-shaped members 131, 132 are provided on outer faces of ear-shaped members 119A, 119B, respectively.

Referring again to FIG. 6, curved-face regions 111a, 111b having inwardly-cut opposing sides so as to fit to the shape of crotch of baby 2000 are formed in crotch portion holding member 110. Additional pad member 111, 112 are provided so as to augment curved-face regions 111a, 111b. As an inner face portion of crotch portion holding member 110 is a region with which baby 2000 comes in contact, a breathable cushion member is employed.

Additional pad members 111, 112 aim to mitigate abutment of the pad members to the crotch portion of baby 2000, and to eliminate discomfort to the crotch portion of baby 2000 either in forward-facing or rearward-facing state (shown in FIGS. 2 and 3). Therefore, additional pad members 111, 112 are preferably provided with a cushion member softer than that provided in the inner face portion of crotch portion holding member 110. In addition, seams are preferably arranged in a position that does not abut the crotch portion of baby 2000.

Referring again to FIG. 7, a loop 134 is attached to the outer face of crotch portion holding member 110, so as to form a passage region with crotch portion holding member 110.

Referring again to FIG. 6, a through path 114 extending horizontally is provided at the tip end portion of abdomen portion holding member 113. A belt 115 is arranged inside through path 114. Hook members 116, 117 capable of adjustment of length of belt 115 are provided at tip end portions on opposing sides of belt 115. As an inner face portion of abdomen portion holding member 113 is a region with which baby 2000 comes in contact, a breathable cushion member is employed.

Referring to FIG. 7, a fastener rail 133 is provided on an outer face of a boundary region between crotch portion holding member 110 and abdomen portion holding member 113. On fastener rail 133, a fastener 133A is provided, and on fastener 133A, a snap button 133B is provided.

Referring to FIGS. 6 and 8, back portion holding member 118 includes baby pad members 118b, 118c as a core material. In contrast to upper pad member 118b, lower pad member 118c is attached so as to flex inward (opposite to the side where band-shaped support member 128 described later is provided). Surfaces of baby pad members 118b, 118c are covered with a breathable cushion member.

With regard to baby pad members 118b, 118c, space 101A provided between back face holding member 101 and sack member 101a can store lower pad member 118c. Hook and loop fasteners 135, 136 are provided between back face holding member 101 and lower pad member 118c, which means that back face holding member 101 is detachable from lower pad member 118c.

As shown in FIG. 7, band-shaped support member 128 is provided outside back portion holding member 118, from an upper end portion of back portion holding member 118 as far as crotch portion holding member 110, Band-shaped support member 128 is fixed to back portion holding member 118 only at its upper end portion. In addition, as shown in FIG. 8, in a region positioned outside baby pad member 118b, band-shaped support member 128 is attached to back portion holding member 118 so as to form a space 128a for insertion of a hand of mother 1000, who is the user.

A belt 129 is attached to a lower tip end portion of band-shaped support member 128. A hook member 130B capable of adjustment of length of belt 129 is provided at the tip end portion of belt 129.

In addition, as shown in FIG. 9, when band-shaped support member 128 is not used, it can be stored in space 101A provided between back face holding member 101 and sack member 101a.

A fan-shaped head protection pad 127 for protecting a head region of baby 2000 and fabricated with a soft cushion member is provided at an upper end portion of back portion holding member 118. Head protection pad 127 is provided so as to allow selection between a position facing inward as shown in FIG. 8 and a position facing outward as shown in FIG. 9.

In addition, head supports 120, 121 as shown in FIGS. 6 and 7 are provided on left and right sides of the upper end portion of back portion holding member 118. At the tip end portion of head support 120, two snap buttons 126 having an engaging region outside are provided. Moreover, a belt 122 is provided, and at the tip end portion thereof, a male buckle 124 capable of adjustment of length of belt 122 is provided. At the tip end portion of head support 121, two snap buttons 126 having an engaging region outside are provided. Moreover, a belt 123 is provided, and at the tip end portion thereof, a male buckle 125 capable of adjustment of length of belt 123 is provided.

Referring to FIG. 7, a sack member 120B forming a space 120A with head support 120 is attached to an outer face of head support 120, and gather G is provided at an opening end portion of sack member 120B. When belt 122 is not used, it is stored in space 120A. A sack member 121B forming a space 121A with head support 121 is attached to an outer face of head support 121, and gather G is provided at an opening end portion of sack member 121B. When belt 123 is not used, it is stored in space 121A.

(Structure of User Wear Member 200)

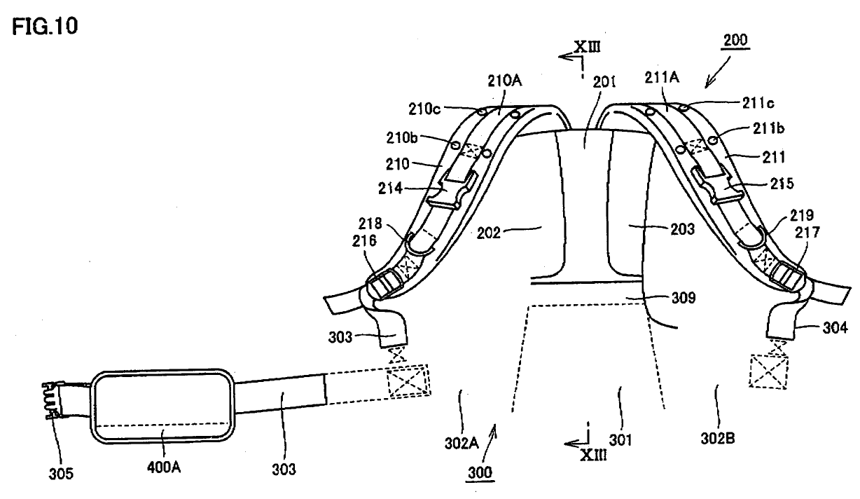

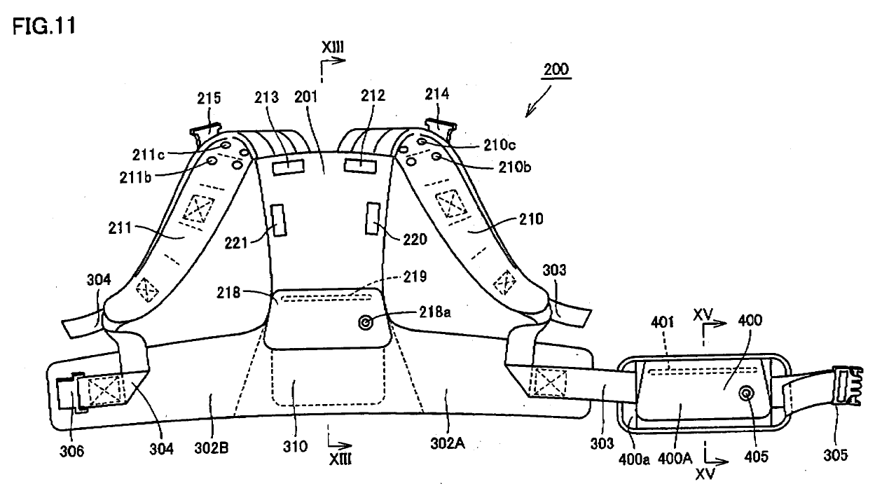

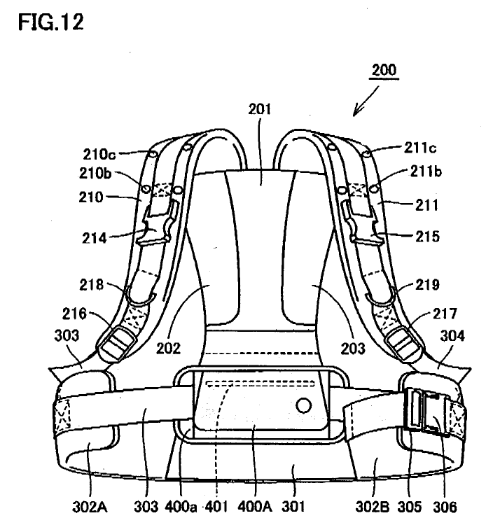

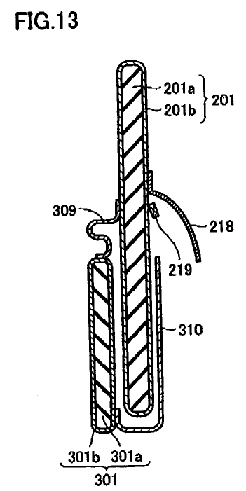

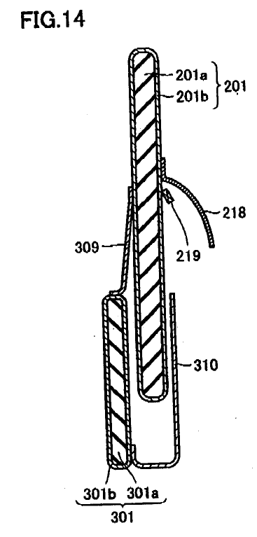

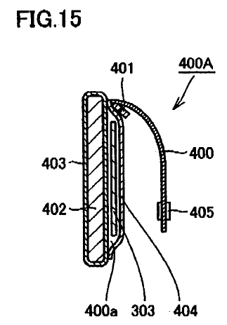

Next, referring to FIGS. 10 to 15, a structure of user wear member 200 will be described. Here, FIG. 10 is a front view showing a state in which user wear member 200 is spread; FIG. 11 is a rear view showing a state in which user wear member 200 is spread; FIG. 12 is a front view showing a state in which user wear member 206 is dosed; FIGS. 13 and 14 are first and second cross-sectional views in line XIII-XIII in a direction of an arrow in FIG. 11; and FIG. 15 is a cross-sectional view in line XV-XV in a direction of the arrow in FIG. 11.

Referring to FIGS. 10 to 12, user wear member 200 aims to be worn by mother 1000, who is the user. User wear member 200 includes a user back pad member 201, and a pair of shoulder belts 210, 211 provided so as to extend upward from the upper end portion of user back pad member 201. In addition, in the present embodiment, a waist belt 300 worn around the waist of mother 1000 is provided in a lower end region of user wear member 200.

As shown in the cross-sectional view in FIG. 13, user back pad member 201 is provided with a core material 201a and a breathable cushion material 201b for covering core material 201a. Referring again to FIGS. 10 to 12, a pair of shoulder belts 210, 211 is provided from the upper end portion of user back pad member 201. In an upper portion of shoulder belt 210, two snap buttons 210b and two snap buttons 210c having an engaging region inside are provided. Similarly, in an upper portion of shoulder belt 211, two snap buttons 211b and two snap buttons 211c having an engaging region inside are provided.

A reinforcement belt 210A is attached to a center region on the outer face of shoulder belt 210. A female buckle 214 is attached to the center region of reinforcement belt 210A so as to be able to slide along a direction in which reinforcement belt 210A extends. In addition, a loop 218 is provided in reinforcement belt 210A below female buckle 214. A ring 216 for adjusting length is attached to the lower end portion of reinforcement belt 210A so as to adjust length of a reinforcement belt 303 provided in the waist belt which will be described later.

A reinforcement belt 211A is attached to a center region on the outer face of shoulder belt 211. A female buckle 215 is attached to the center region of reinforcement belt 211A so as to be able to slide along a direction in which reinforcement belt 211A extends. In addition, a loop 219 is provided in reinforcement belt 211A below female buckle 215. A ring 217 for adjusting length is attached to the lower end portion of reinforcement belt 211A so as to adjust length of a reinforcement belt 304 provided in the waist belt which will be described later.

In addition, pad members 202, 203 are provided in a back region abutting shoulder portions of mother 1000, on an inner face of user back pad member 201.

On the outer face of user back pad member 201, loops 212, 213 longitudinally forming passage regions are provided in the vicinity of shoulder belts 210, 2111, as shown in FIG. 11, and loops 220, 221 horizontally forming passage regions axe provided outside the center region.

In the lower region of user back pad member 201, waist belt 300 is provided so as to extend horizontally. Waist belt 300 includes a center region 301, and side regions 302A, 302B. Waist belt 300 exhibits a horizontal band-like shape as a whole, and has a surface fabricated with a breathable cushion member.

In center region 301, a sack-shaped guide member 310 for forming a guide region for storing the lower end portion of user back pad member 201 and guiding user back pad member 201 in such a manner that it can slide upward and downward is provided, as shown in the cross-section in FIG. 13. In addition, in order to fully receive force from user back pad member 201, center region 301 includes a core material 301a and a breathable cushion member 301b provided so as to cover core material 301a.

Further, between user back pad member 201 and center region 301, a connection member 309 for connecting user back pad member 201 to center region 301 so as to prevent detachment of user back pad member 201 from center region 301 is provided. Consequently, a state shown in FIG. 13 indicates a position where user back pad member 201 is closest to center region 301, while FIG. 14 shows a state in which user back pad member 201 is most distant from center region 301.

It is to be noted that core material 301a is not necessarily required, and need not be provided if force distribution is sufficiently achieved by user back pad member 201.

Referring to FIGS. 11 and 13, on the outer face of user back pad member 201, fastener rail 219 extending horizontally is provided in a region in the vicinity of an upper portion of sack-shaped guide member 310. In addition, fastener cover 218 is provided so as to cover fastener rail 219 in a downward direction. A snap button 218a having an engaging region outside is provided on the outer face of fastener cover 218.

Referring to FIG. 11, reinforcement belt 303 is attached to an outer face of side region 302A of waist belt 300. One end of reinforcement belt 303 engages to ring 216 for adjusting length, and the other end thereof extends with sufficient length so as to surround the abdomen of mother 1000, Reinforcement belt 303 has a male buckle 305 attached to the tip end portion on the other end, which allows length adjustment.

Moreover, a reinforcement pad 400A is provided in reinforcement belt 303. Referring to FIGS. 11 and 15, reinforcement pad 400A includes a core material 402, a cushion member 403 covering core material 402, and a loop member 404 forming a space 400a for passage of reinforcement belt 303. In addition, a fastener rail 401 is provided at the upper end portion of loop member 404. A fastener cover 400 is provided so as to cover fastener rail 401 in a downward direction. A snap button 405a having an engaging region outside is provided on an outer face of fastener cover 400.

Here, the reason for providing a storage space to store the connection member and enabling storage of a prescribed member in the storage space in the embodiment above is as follows. In states of use shown in FIGS. 1 to 5, there are members that are used and are not used. For members not used, appearance in terms of design is improved by storing those members in the storage space. Moreover, if the members which are not to be used are stored in advance, misuse can be avoided. In the present embodiment, although the storage space has been provided in advance, a structure may be adopted, in which each member is detachable, and is attached only during use, and detached while not in use.

(Coupling Relation Between Baby Holding Member 100 and User Wear Member 200)

Next, referring again to FIGS. 1 to 5, a coupling relation between baby holding member 100 and user wear member 200 in each state of use will be described.

As described above, baby carrier 1 in the present embodiment is characterized by ability of selecting a coupling relation between baby holding member 100 and user wear member 200, that is, selecting states in the following. In other words, a state in which baby 2000 can be held laterally on the front side of mother 1000, who is the user, as shown in FIG. 1; a state in which baby 2000 can be held vertically on the front side of mother 1000 (facing state), as shown in FIG. 2: a state in which baby 2000 can be held in a forward-facing and vertical manner on the front side of mother 1000 with an upper body region of baby holding member 100 removed, as shown in FIG. 3; a state in which baby 2000 can be held vertically on the back side of mother 1000 (baby 2000 faces forward) as shown in FIG. 4; and a state in which baby 2000 can be held in a rearward-facing and vertical manner on the back side of mother 1000 with the upper body region of baby holding member 100 removed, as shown in FIG. 5.

(Lateral Hold Connection State)

First, referring to FIG. 1, the first connection portion for enabling lateral hold of the baby that is laid down, using baby holding member 100 will be described.

In order to enable lateral hold, male buckle 124 provided in belt 122 extending from head support 120 of baby holding member 100 is connected to female buckle 214 provided in shoulder belt 210 of user wear member 200.

In addition, male buckle 125 provided in belt 123 extending from head support 121 of baby holding member 100 is connected to female buckle 215 provided in shoulder belt 211 of user wear member 200.

Further, band-shaped support member 128 provided in baby holding member 100 passes through the crotch portion of baby 2000. Then, belt 129 provided at the tip end portion of band-shaped support member 128 passes through loop 134, and hook member 130B provided at the tip end of belt 129 engages to loop 218 provided in shoulder belt 210.

Here, female buckle 214 and male buckle 124 as well as female buckle 215 and male buckle 125 form a lateral hold upper portion connection portion, while hook member 130B and loop 218 form a lateral hold lower portion connection portion.

In addition, in order to protect the lower abdomen of baby 2000, hook member 117 attached to belt 115 provided in abdomen portion holding member 113 engages to ring-shaped member 132 provided in ear-shaped member 119B. Though not shown, hook member 116 provided on the opposite side of belt 115 also engages to ring-shaped member 131 provided in ear-shaped member 119A in a similar manner. Here, as described above, if length of belt 115 can be adjusted by means of hook members 116, 117, positioning of abdomen portion holding member 113 adapted to the dimension of the leg opening for baby 2000 can be achieved, and appropriate protection of the lower abdomen of the baby can be attained.

Though FIG. 1 shows an example in which the head of baby 2000 is located on the left arm side of mother 1000, an example in which the head of baby 2000 is located on the right arm side thereof can be implemented by adopting a similar coupling state.

In lateral hold, the head side of baby 2000 is supported at two points, and the back portion of baby 2000 is supported such that it is covered overall by band-shaped support member 128 passing the crotch portion from the head side. That is, a three-point supporting structure is adopted. Thus, stable lateral hold of baby 2000 can be implemented.

Extension portions 104, 105, belt members 106, 107, and male buckles 108, 109 provided in baby holding member 100 are not used in this state of use, and accordingly, they are stored in spaces 102A, 103A. Therefore, misuse thereof can be avoided, and uncluttered impression can be obtained, in terms of design.

(Front Side Vertical Hold Connection State)

Next, referring to FIG. 2, the second connection portion for enabling vertical hold of baby 2000, using baby holding member 100 on the front side of mother 1000 will be described.

In order to enable front side vertical hold, two snap buttons 210b provided in shoulder belt 210 of user wear member 200 are mated with two snap buttons 126 provided in head support 121 of baby holding member 100. Here, as belt 121 extending from head support 121 of baby holding member 100 is not used, it is stored in space 121A in advance.

In addition, male buckle 109 provided at the tip end of belt member 107 extending from extension portion 105 of baby holding member 100 is connected to female buckle 214 provided in shoulder belt 210 of user wear member 200.

Further, two snap buttons 211b provided in shoulder belt 211 of user wear member 200 are mated with two snap buttons 126 provided in head support 120 of baby holding member 100. Here, as belt 122 extending from head support 120 of baby holding member 100 is not used, it is stored in space 120A in advance.

Though not shown, male buckle 108 provided at the tip end of belt member 106 extending from extension portion 104 of baby holding member 100 is connected to female buckle 215 provided in shoulder belt 211 of user wear member 200.

In addition, though not shown, fastener rail 133 provided in baby holding member 100 is coupled to fastener rail 401 provided in reinforcement pad 400A of user wear member 200, using fastener 133A. In order to prevent movement of fastener 133A, snap button 133B provided in fastener 133A is mated with snap button 405a provided in fastener 400.

Here, two snap buttons 210b and two snap buttons 126 on shoulder belt 210 side as well as two snap buttons 211b and two snap buttons 126 on shoulder belt 211 side form a front side vertical hold upper portion connection portion; female buckle 214 and male buckle 109 on shoulder belt 210 side as well as female buckle 215 and male buckle 108 on shoulder belt 211 side form a front side vertical hold intermediate portion connection portion; and fastener rail 133, fastener rail 401, and fastener 133A form a front side vertical hold lower end portion connection portion.

In addition, in order to protect the lower abdomen of baby 2000, hook member 117 attached to belt 115 provided in abdomen portion holding member 113 engages to ring-shaped member 132 provided in ear-shaped member 119B. Though not shown, hook member 116 provided on the opposite side of belt 115 also engages to ring-shaped member 131 provided in ear-shaped member 119A in a similar manner.

In vertical hold, the head side of baby 2000 is supported at two points, the side face of the abdomen thereof is supported at two points, and the crotch portion thereof is supported at one point. That is, a five-point support structure is adopted. Therefore, stable vertical hold of baby 2000 can be achieved. In addition, head supports 120, 121 are arranged on the side faces of the head of baby 2000, sway of the head thereof is prevented, and protection of the head and a neck region thereof can be achieved.

Moreover, on the back face side of back portion holding member 118 of baby holding member 100, space 128a is formed by band-shaped support member 128. By inserting a hand 1001 of mother 1000 in space 128a for support, baby 2000 can be held in a further stable manner.

When baby 200 grows and its neck and lower body are stable, and when keeping baby 2000 in an upright posture is not medically problematic, baby 2000 can be held in a forward-facing and vertical manner by removing back portion holding member 118 from baby holding member 100, as shown in FIG. 3.

Further, belt members 121, 122, male buckles 124, 125, and band-shaped support member 128 provided in baby holding member 100 are not used in this state of use, and accordingly, they are stored in spaces 120A, 121A, 101A, respectively. Therefore, misuse thereof can be avoided, and uncluttered impression can be obtained, in terms of design.

(Back Side Vertical Hold Connection State)

Next, referring to FIG. 4, the third connection portion for enabling vertical hold of baby 2000, using baby holding member 100 on the back side of mother 1000 will be described.

In order to enable back side vertical hold, two snap buttons 211c provided in shoulder belt 211 of user wear member 200 are mated with two snap buttons 126 provided in head support 121 of baby holding member 100. Here, as belt 121 extending from head support 121 of baby holding member 100 is not used, it is stored in space 121A in advance.

In addition, male buckle 109 provided at the tip end of belt member 107 extending from extension portion 105 of baby holding member 100 is connected to female buckle 215 provided in shoulder belt 211 of user wear member 200. Here, in order to prevent displacement of belt member 107, belt member 107 passes through loop 213.

Moreover, two snap buttons 210c provided in shoulder belt 210 of user wear member 200 are mated with two snap buttons 126 provided in head support 120 of baby holding member 100. Here, as belt 122 extending from head support 120 of baby holding member 100 is not used, it is stored in space 120A in advance. Here, in order to prevent displacement of belt member 106, belt member 107 passes through loop 212.

Further, male buckle 108 provided at the tip end of belt member 106 extending from extension portion 104 of baby holding member 100 is connected to female buckle 214 provided in shoulder belt 210 of user wear member 200.

Though not shown, fastener rail 133 provided in baby holding member 100 is coupled to fastener rail 219 provided in user back pad member 201 of user wear member 200, using fastener 133A. In order to prevent movement of fastener 133A, snap button 133B provided in fastener 133A is mated with snap button 218a provided in fastener cover 218.

Here, two snap buttons 211c and two snap buttons 126 on shoulder belt 211 side as well as two snap buttons 210c and two snap buttons 126 on shoulder belt 210 side form a back side vertical hold upper portion connection portion; female buckle 215 and male buckle 109 on shoulder belt 211 side as well as female buckle 214 and male buckle 108 on shoulder belt 210 side form a back side vertical hold intermediate portion connection portion; and fastener rail 133, fastener rail 219, and fastener 133A form a front side vertical hold lower end portion connection portion.

In addition, in order to protect the lower abdomen of baby 2000, hook member 117 attached to belt 115 provided in abdomen portion holding member 113 engages to ring-shaped member 131 provided in ear-shaped member 119A. Though not shown, hook member 116 provided on the opposite side of belt 115 also engages to ring-shaped member 131 provided in ear-shaped member 119B in a similar manner. Here, in order to prevent movement of the lower abdomen of baby 2000, belt member 115 passes through loops 220, 221 provided in user wear member 200.

In vertical hold, the head side of baby 2000 is supported at two points, the side face of the abdomen thereof is supported at two points, and the crotch portion thereof is supported at one point. That is, a five-point support structure is adopted. Therefore, stable vertical hold of baby 2000 can be achieved. In addition, head supports 120, 121 are arranged on the side faces of the head of baby 2000, sway of the head of baby 2000 is prevented, and protection of the head and a neck region thereof can be achieved.

When baby 2000 grows, and its neck and lower body are stable, and when keeping baby 2000 in an upright posture is not medically problematic, baby 2000 can be held in a rearward-facing and vertical manner by removing back portion holding member 118 from baby holding member 100, as shown in FIG. 5.

Further, belt members 121, 122, male buckles 124, 125, and band-shaped support member 128 provided in baby holding member 100 are not used in this state of use, and accordingly, they are stored in spaces 120A, 121A, 101A, respectively. Therefore, misuse thereof can be avoided, and uncluttered impression can be obtained, in terms of design.

As described above, baby carrier 1 in the present embodiment can be used in lateral hold, front side vertical hold, and back side vertical hold. Therefore, baby carrier 1 can be used from a neonatal period.

Moreover, curved-face regions 111a, 111b are provided in crotch portion holding member 110 of baby holding member 100, as described above. In addition, length of each belt connecting baby holding member 100 to user wear member 200 can be adjusted. Thus, as described above, in front side vertical hold and back side vertical hold, baby 1000 can be held in a forward-facing or rearward-facing manner while baby holding member 100 is attached to user wear member 200.

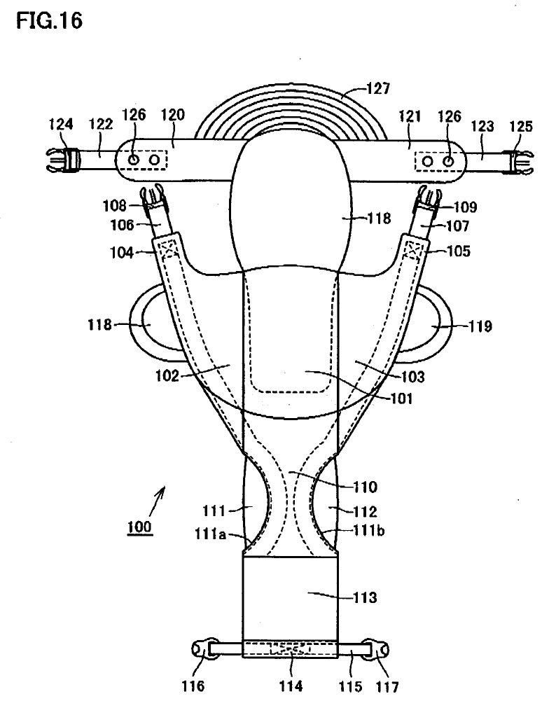

As another form of the embodiment above, from the viewpoint of strength, a structure in which belts 106, 107 provided in baby holding member 100 extend as far as a lower region so as to cross each other in a region of crotch portion holding member 110 is possible (see FIG. 6). When belts 106, 107 cross each other in the region of crotch portion holding member 110, however, the crossing portion may form a bulge, and this may make baby 2000 uncomfortable. In such a case, as shown in FIG. 16, belts 106, 107 are disposed along curved-face regions 111a, 111b of crotch portion holding member 110. Thus, strength is improved, and discomfort to baby 2000 can be eliminated.

In addition, in the embodiment above, though waist belt 300 has been provided in order to implement stable holding of baby 2000, waist belt 300 is not necessarily provided if the weight of baby 2000 can be supported solely by shoulder belts. Moreover, though the shoulder belt is provided in a pair on left and right sides, single shoulder belt formed in a crossed manner may be employed.

(Second Embodiment)

In the following, a baby carrier 1B in the second embodiment according to the present invention will be described with reference to the figures.

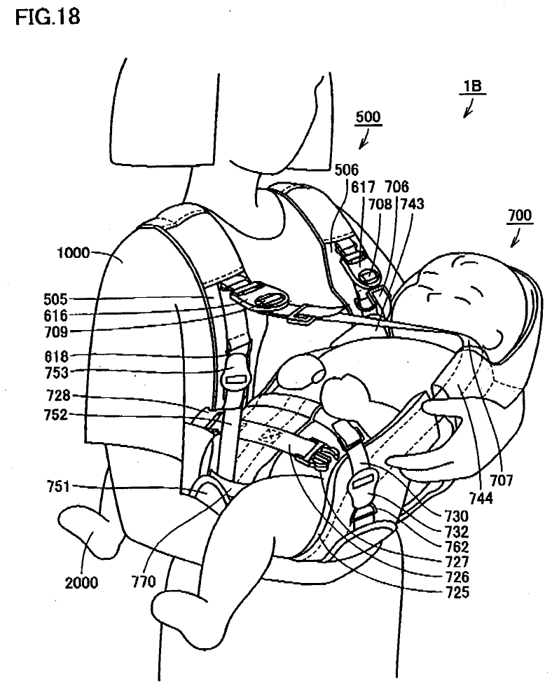

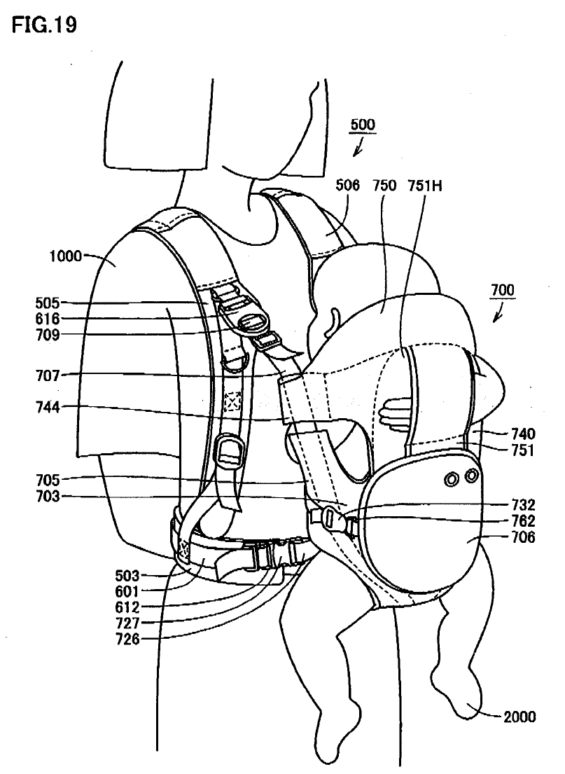

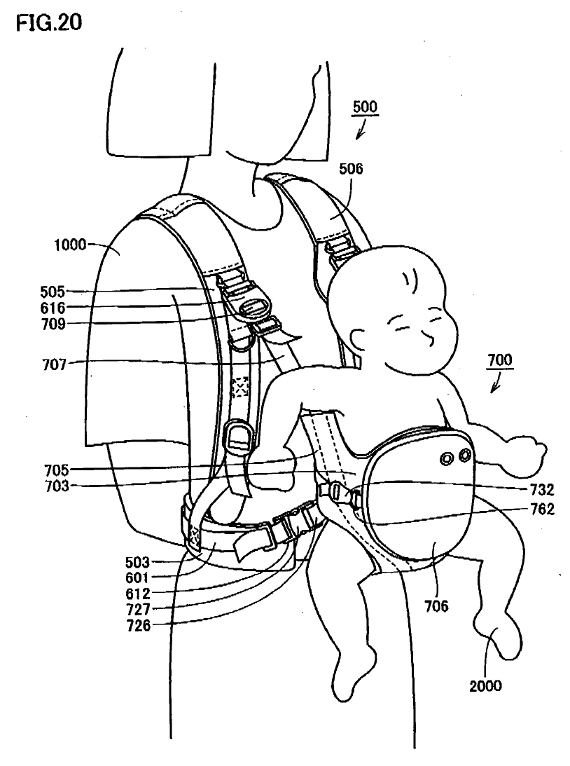

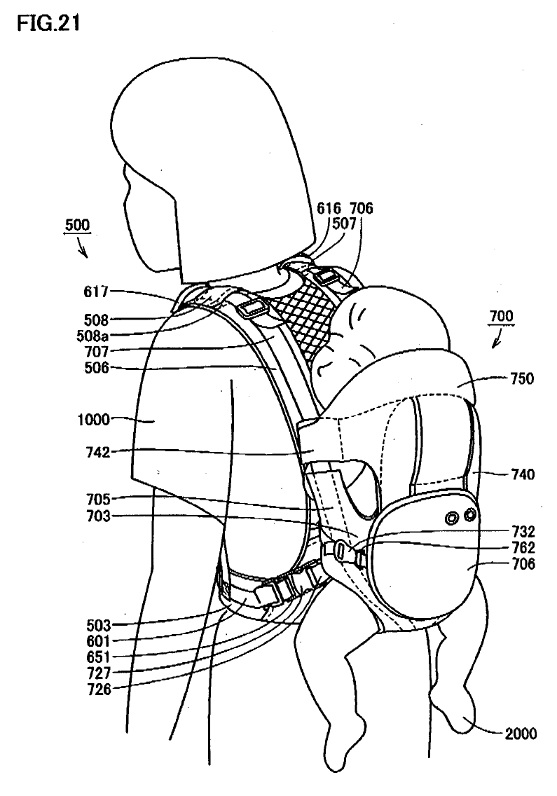

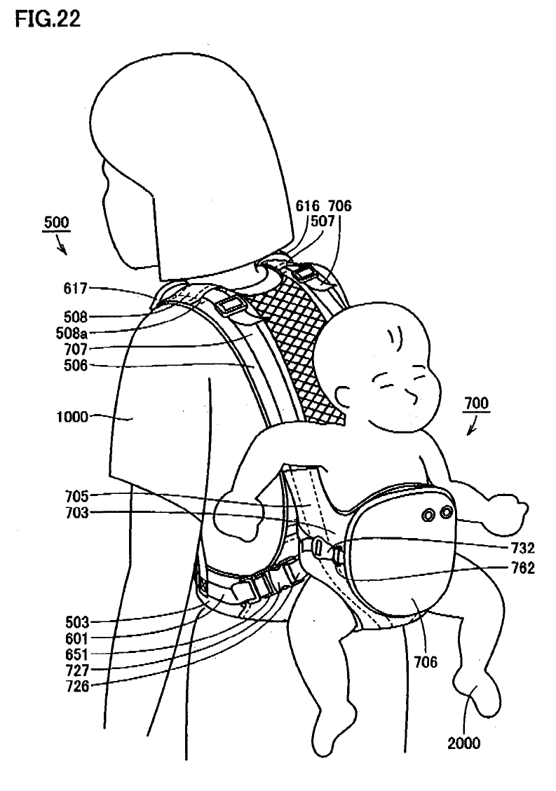

First, baby carrier 1B in the present embodiment is characterized by including a baby holding member 700 and a backpack type user wear member 500, as shown in FIG. 18. Baby carrier 1B is also characterized by selectably providing states in the following. That is, a state in which baby 2000 can be held laterally on the front side of mother 1000, who is the user; a state in which baby 2000 can be held vertically on the front side of mother 1000 (facing state), as shown in FIG. 19; a state in which baby 2000 can be held in a forward-facing and vertical manner on the front side of mother 1000 with an upper body region of baby holding member 700 removed, as shown in FIG. 20; a state in which baby 2000 can be held vertically on the back side of mother 1000 baby 2000 faces forward) as shown in FIG. 21; and a state in which baby 2000 can be held in a rearward-facing and vertical manner on the back side of mother 1000 with the upper body region of baby holding member 700 removed, as shown in FIG. 22.

Here, between baby holding member 700 and user wear member 500, provided are: a first connection portion for enabling lateral hold of baby 2000 that is laid down, using baby holding member 700 on a front side of mother 1000 in a state shown in FIG. 18; a second connection portion for enabling front side vertical hold of baby 2000 in an upright posture, using baby holding member 700 on the front side of mother 1000 in a state shown in FIGS. 19 and 20; and a third connection portion for enabling back side vertical hold of baby 2000 in an upright posture, using baby holding member 700 on the back side of mother 1000 in a state shown in FIGS. 21 and 22.

In the following, structures of user wear member 500 and baby holding member 700 will be described with reference to the figures.

(Structure of User Wear Member 500)

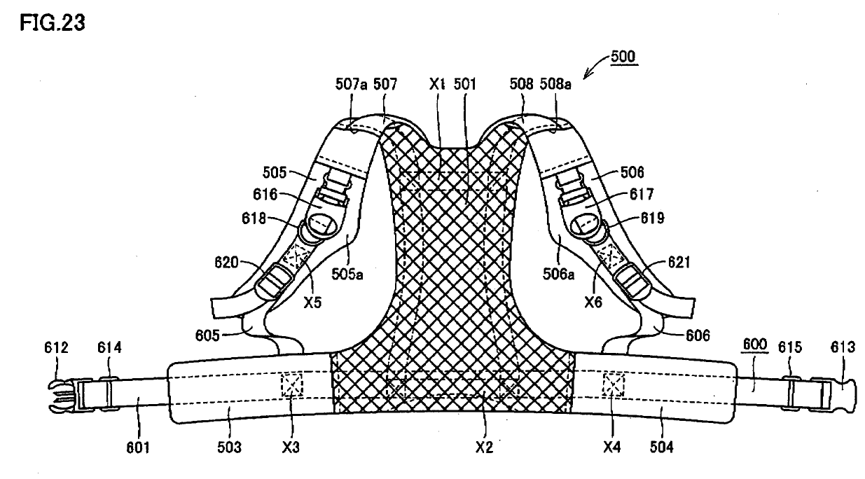

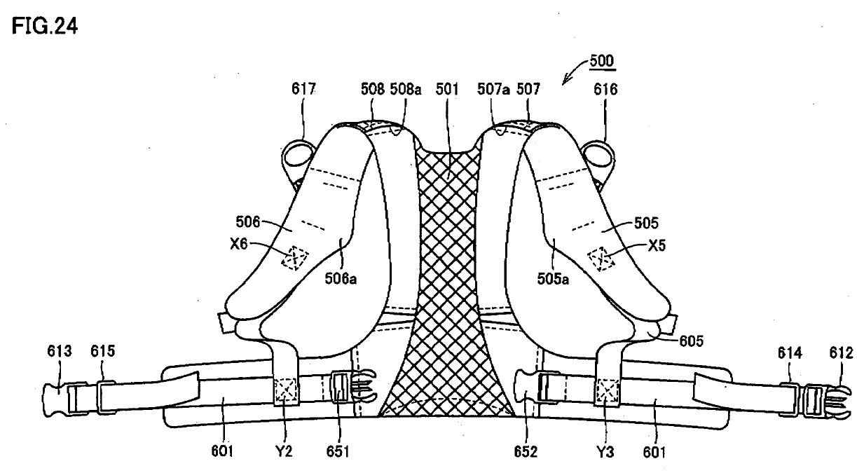

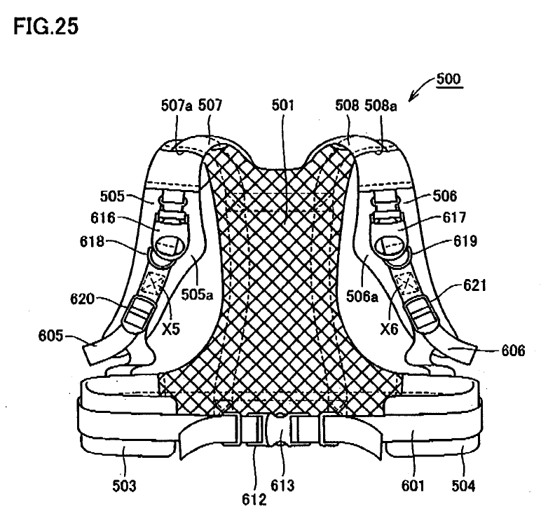

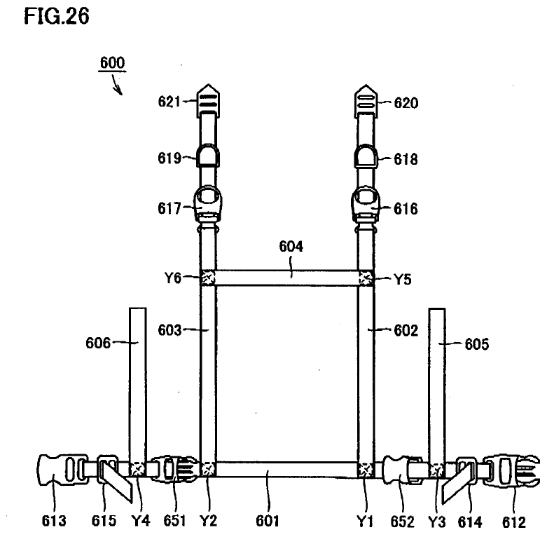

Referring to FIGS. 23 to 26, a structure of user wear member 500 will be described. Here, FIG. 23 is a front view showing a state in which user wear member 500 is spread; FIG. 24 is a rear view showing a state in which user wear member 500 is spread; FIG. 25 is a front view showing a state in which user wear member 500 is closed; and FIG. 26 is a developed view of a belt, solely showing a belt member.

First, referring to FIGS. 23 to 26, user wear member 500 aims to be worn by mother 1000, who is the user. User wear member 500 includes a user back pad member 501, as well as a first shoulder belt member 505 and a second shoulder belt member 506 provided so as to extend upward from the upper end portion of user back pad member 501. In addition, in the present embodiment, waist belt members 503, 504 worn around the waist of mother 1000 are provided in a lower end region of user wear member 500.

User back member 501 is mainly fabricated with a meshed member, taking into account improvement of breathability. First shoulder belt member 505, second shoulder belt member 506, and waist belt members 503, 504 are mainly fabricated with a pad member, for the purpose of mitigating load bearing on the user.

A belt member 600 shown in FIG. 26 is sewn to first shoulder belt member 505, second shoulder belt member 506, and waist belt members 503, 504, in order to bear the load of the baby.

As shown in FIG. 26, belt member 600 includes a waist belt 601; a first shoulder belt 602 firmly connected to waist belt 601 in a region Y1 and provided so as to extend upward; a second shoulder belt 603 firmly connected to waist belt 601 in a region Y2 and provided so as to extend upward; a first extension belt 605 firmly connected to waist belt 601 in a region Y3 and provided so as to extend upward; and a second extension belt 606 firmly connected to waist belt 601 in a region Y4 and provided so as to extend upward. In addition, first shoulder belt 602 is connected to second shoulder belt 603 by a connection belt 604 fixed respectively in regions Y5, Y6. Though connection of each belt is attained by sewing, other connection structure may be adopted if sufficient strength can be obtained.

In first shoulder belt 602, a female buckle 616 and a ring buckle 618 are attached in prescribed positions. An adjustment buckle 620 for adjusting length of the belt is attached to the tip end of first shoulder belt 602. Similarly, a female buckle 617 and a ring buckle 619 are attached in prescribed positions in second shoulder belt 603. An adjustment buckle 621 for adjusting length of the belt is attached to the tip end of second shoulder belt 603.

A male buckle 612 is provided at one end of first extension belt 605 of waist belt 601. Between region Y3 and male buckle 612, an adjustment buckle 614 for adjusting length on one end side of waist belt 601 is attached. In addition, a female buckle 652 is attached to waist belt 601 between region Y3 and region Y1, so as to face inward.

A female buckle 613 is provided at the other end of second extension belt 606 of waist belt 601. Between region Y4 and female buckle 613, an adjustment buckle 615 for adjusting length on the other end side of waist belt 601 is attached. In addition, a male buckle 651 is attached to waist belt 601 between region Y2 and region Y4, so as to face inward.

First shoulder belt member 505, second shoulder belt member 506, and waist belt members 503, 504 are coupled to belt member 600 by sewing, as required. They are firmly connected particularly in regions X2, X3, X4 of waist belt members 503, 504, a region X1 of user back member 501, and regions X5, X6 of first shoulder belt member 505 and second shoulder belt member 506.

In addition, as shown in FIG. 18, a band-shaped member 507 is attached to a top region of first shoulder belt member 505, so as to form a first loop region 507a. A band-shaped member 508 is also attached to a top region of second shoulder belt member 506, so as to form a second loop region 508a. Moreover, a convex pad region 505a facing inward is provided on the front side of first shoulder belt member 505, in order to distribute load bearing on the user. Similarly, a convex pad region 506a facing inward is also provided on the front side of second shoulder belt member 506.

As shown in FIG. 24, male buckle 651 and female buckle 652 provided in waist belt 601 are exposed. On the other hand, a structure in which a storage region is provided in a lower end portion of user back member 501, and male buckle 651 and female buckle 652 are taken out only during the use is possible, as required.

As shown in FIG. 25, first extension belt 605 is connected to adjustment buckle 620 provided on the side of first shoulder belt member 505. Thus, a right shoulder loop is formed, and length thereof is adjusted. Similarly, second extension belt 606 is connected to adjustment buckle 621 provided on the side of second shoulder belt member 506. Thus, a left shoulder loop is formed, and length thereof is adjusted. Further, by connecting male buckle 612 to female buckle 613 provided at tip end portions of waist belt 601, a loop around the waist is formed.

(Structure of Baby Holding Member 700)

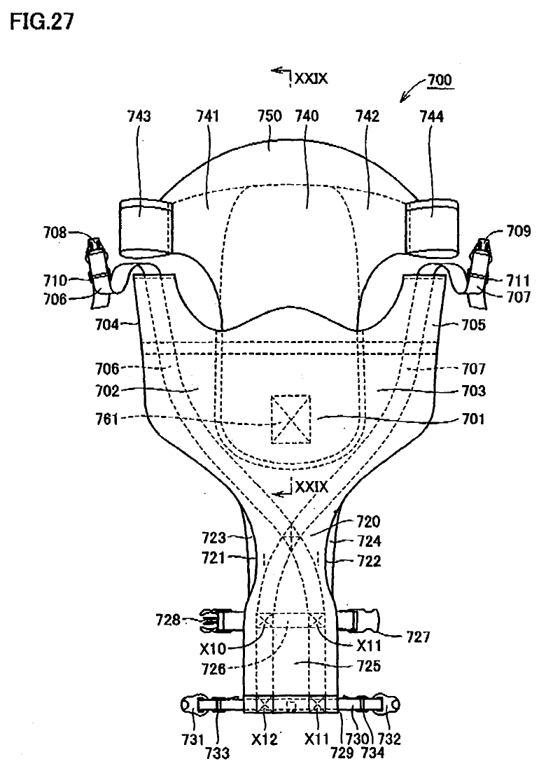

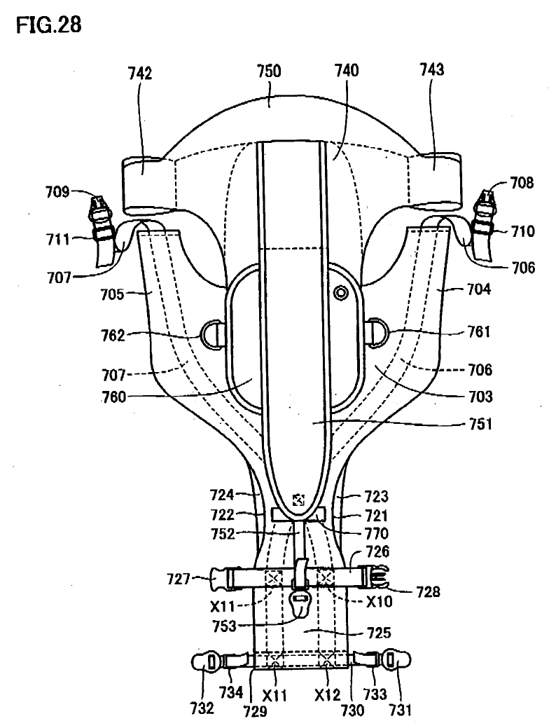

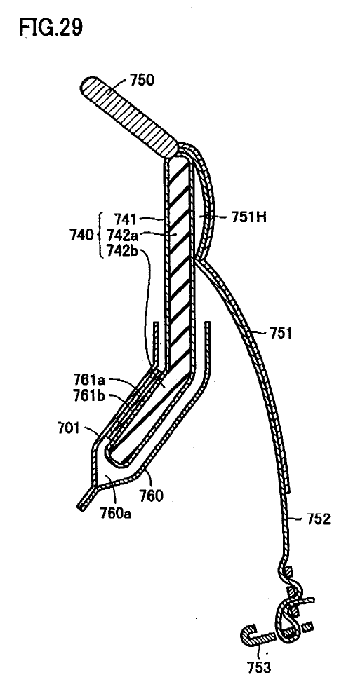

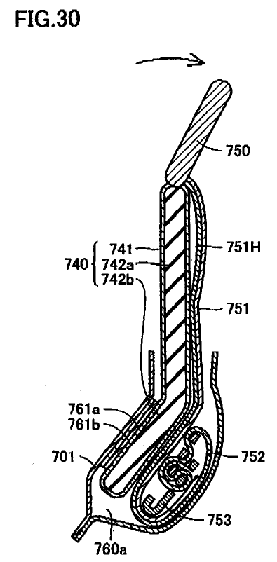

Next, referring to FIGS. 27 to 29, a structure of baby holding member 700 will be described. FIG. 27 is a plan view from an inner face side of baby holding member 700; FIG. 28 is a rear view from an outer face side of baby holding member 700; FIG. 29 is a first cross-sectional view in line XXIX-XXIX in a direction of an arrow in FIG. 27; and FIG. 30 is a second cross sectional view in line XXIX-XXIX in a direction of the arrow in FIG. 27.

Baby holding member 700 in the present embodiment includes a back face holding member 701, a crotch portion holding member 720, an abdomen portion holding member 725, and a back portion holding member 740. Baby holding member 700 exhibits a longitudinal band shape as a whole.

Referring to FIG. 27, side portion holding members 702, 703 are provided on opposite sides of back face holding member 701. Extension portions 704, 705 are provided in respective upper end portions of side portion holding members 702, 703. Belt members 706, 707 are provided in extension portions 704, 705, so as to extend upward. Adjustment buckles 710, 711 for adjusting length of belt members 706, 707 are attached to belt members 706, 707. Male buckles 708, 709 are connected to tip end portions of belt members 706, 707.

In addition, belt members 706, 707 are provided so as to cross in crotch portion holding member 720, and arranged so as to reach the tip end region of abdomen portion holding member 725.

Here, inner face portions of back face holding member 701, side portion holding members 702, 703, and extension portions 704, 705 are regions with which baby 2000 comes in contact. Therefore, a breathable cushion member is employed.

Referring to FIG. 28, a sack member 760 is provided on an outer face of back face holding member 701. Sack member 760 is attached so as to have an upward opening. A space 760a formed between back face holding member 701 and sack member 760 can store a band-shaped support member 751, which will be described later. In addition, ring-shaped members 761, 762 are provided outside sack member 760, respectively.

Referring again to FIG. 27, curved-face regions 721, 722 having inwardly-cut opposing sides so as to fit to the shape of crotch of baby 2000 are formed in crotch portion holding member 720. Additional pad members 723, 724 are provided so as to augment curved-face regions 721, 722. As an inner face portion of crotch portion holding member 720 is a region with which baby 2000 comes in contact, a breathable cushion member is employed.

Additional pad members 723, 724 aim to mitigate abutment of the pad members to the crotch portion of baby 2000, and to eliminate discomfort to the crotch portion of baby 2000 either in forward-facing or rearward-facing state (shown in FIGS. 19 and 20). Therefore, preferably, a cushion member softer than that provided in the inner face portion of crotch portion holding member 720 is employed. In addition, seams are preferably arranged in a position that does not abut the crotch portion of baby 2000.

Referring again to FIG. 28, a loop 770 is attached to an outer face of crotch portion holding member 720, so as to form a passage region with crotch portion holding member 720.

Referring again to FIG. 27, a through path 729 extending horizontally is provided at the tip end portion of abdomen portion holding member 725. A tip end side belt 730 is arranged inside through path 729. On opposing sides of tip end side belt 730, adjustment buckles 733, 734 for adjusting length of the belt are provided. In addition, at the tip end portion, hook members 731, 732 are provided.

Moreover, an abdomen portion belt 726 is attached to the center region of abdomen portion holding member 725, so as to extend horizontally. A male buckle 727 is provided on one end of abdomen portion belt 726, while a female buckle 728 is provided on the other end thereof.

As described above, belt members 706, 707 are arranged to reach as far as the tip end region of abdomen portion holding member 725. From the viewpoint of effective distribution of the load of the baby, however, belt members 706, 707 are attached and connected to abdomen portion belt 726 in regions X10, X11, while belt members 706, 707 are attached and connected to tip end side belt 730 in regions X12, X13.

Here, since an inner face portion of abdomen portion holding member 725 is a region with which baby 2000 comes in contact, a breathable cushion member is employed.

Referring to FIGS. 27 to 29, back portion holding member 740 includes baby pad members 742a, 742b as a core material. In contrast to upper pad member 742a, lower pad member 742b is attached so as to flex inward (opposite to the side where band-shaped support member 751 described later is provided). Surfaces of baby pad members 742a, 742b are covered with a breathable cushion member 741.

In addition, sidewall pads 741, 742 hanging to the left and right are provided on opposing sides of an upper portion of back portion holding member 740, and a head protection pad 750 is provided on the upper side of back portion holding member 740 and sidewall pads 741, 742. Moreover, a first support loop 743 for passing belt member 706 and a second support loop 744 for passing belt member 707 are provided in end portions on opposing sides of sidewall pads 741, 742.

Head protection pad 750, first support loop 743 and second support loop 744 are fabricated with a soft cushion member. Head protection pad 750 is provided so as to allow selection between a position facing inward as shown in FIG. 29 and a position facing outward as shown in FIG. 30.

In back portion holding member 740, a space 760a provided between back face holding member 701 and a sack member 760 can store lower pad member 742b. Hook and loop fasteners 761a, 761b are provided between back face holding member 701 and lower pad member 742b, which means that back face holding member 701 is detachable from lower pad member 742b.

As shown in FIG. 28, band-shaped support member 751 is provided outside back portion holding member 740, from an upper end portion of back portion holding member 740 as far as crotch portion holding member 720. Band-shaped support member 751 is fixed to back portion holding member 740 only at its upper end portion. In addition, as shown in FIG. 29, in a region positioned outside baby pad member 742a, band-shaped support member 751 is attached to back portion holding member 740 so as to form a space 751H for insertion of a hand of mother 1000, who is the user.

Belt 752 is attached to a lower tip end portion of band-shaped support member 751. At the tip end portion of belt 752, a hook member 753 capable of adjustment of length of belt 752 is provided.

In addition, as shown in FIG. 30, when band-shaped support member 751 is not used, it can be stored in space 760a provided between back face holding member 701 and sack member 760.

(Coupling Relation Between User Wear Member 500 and Baby Holding Member 700)

Next, referring again to FIGS. 18 to 20, a coupling relation between user wear member 500 and baby holding member 700 in each state of use will be described.

As described above, baby carrier 1B in the present embodiment is characterized by ability of selecting a coupling relation between user wear member 500 and baby holding member 700, that is, selecting states in the following. In other words, a state in which baby 2000 can be held laterally on the front side of mother 1000, who is the user, as shown in FIG. 18; a state in which baby 2000 can be held vertically on the front side of mother 1000 (facing state), as shown in FIG. 19; a state in which baby 2000 can be held in a forward-facing and vertical manner on the front side of mother 1000 with an upper body region of baby holding member 700 removed, as shown in FIG. 20; a state in which baby 2000 can be held vertically on the back side of mother 1000 (baby 2000 faces forward) as shown in FIG. 21; and a state in which baby 2000 can be held in a rearward-facing and vertical manner on the back side of mother 1000 with the upper body region of baby holding member 700 removed, as shown in FIG. 22.

(Lateral Hold Connection State)

First, referring to FIG. 18, the first connection portion for enabling lateral hold of the baby that is laid down, using baby holding member 700 will be described.

In order to enable lateral hold, female buckle 616 provided in shoulder belt 602 of user wear member 500 is connected to male buckle 709 of belt member 707. Here, belt member 707 passes through second support loop 744. Similarly, female buckle 617 provided in shoulder belt 603 is connected to male buckle 708 of belt member 706. Here, belt member 706 passes through first support loop 743.

Further, band-shaped support member 751 provided in baby holding member 700 passes through the crotch portion of baby 2000. Then, belt 752 provided at the tip end portion of band-shaped support member 751 passes through loop 770, and hook member 753 provided at the tip end of belt 752 engages to ring buckle 618 provided in shoulder belt 602.

Here, female buckle 616 and male buckle 709 as well as female buckle 617 and male buckle 708 form a lateral hold upper portion connection portion, while hook member 753 and ring buckle 618 form a lateral hold lower portion connection portion.

In addition, in order to protect the lower abdomen of baby 2000, hook member 732 attached to tip end side belt 730 provided in abdomen portion holding member 725 engages to ring-shaped member 762. Though not shown, hook member 731 attached to tip end side belt 730 also engages to ring-shaped member 761.

In such a state, male buckle 612 and female buckle 613 provided at opposing tip end portions of waist belt 601 of user wear member 500 are connected to each other. Thus, stable wearing of waist belt 601 in the waist region of mother 1000 is achieved.

Though FIG. 18 shows an example in which the head of baby 2000 is located on the left arm side of mother 1000, an example in which the head of baby 2000 is located on the right arm side thereof can be implemented by adopting a similar coupling state.

As described above, in lateral hold, the head side of baby 2000 is supported at two points, and the back side portion thereof is supported such that it is covered overall by band-shaped support member 751 passing the crotch portion from the head side. That is, a three-point supporting structure is adopted. Thus, stable lateral hold of baby 2000 can be attained.

Moreover, second support loop 744 supported by belt member 707 and first support loop 743 supported by belt member 706 are disposed on side portions of the baby. Therefore, a wall by first support loop 743 and second support loop 744 is formed on the side portions of the baby, and protection of the side portions of the baby can be ensured. As a result, sway of the head is prevented, and the baby carrier with a structure implementing sufficient protection of the baby's head can be provided.

(Front Side Vertical Hold Connection State)

Next, referring to FIG. 19, the second connection portion for enabling vertical hold of baby 2000, using baby holding member 700 on the front side of mother 1000 will be described.

In order to enable front side vertical hold, female buckle 616 provided in shoulder belt 602 of user wear member 500 is connected to male buckle 709 of belt member 707. Here, belt member 707 passes through second support loop 744. Similarly, female buckle 617 provided in shoulder belt 603 is connected to male buckle 708 of belt member 706. Here, belt member 706 passes through first support loop 743.

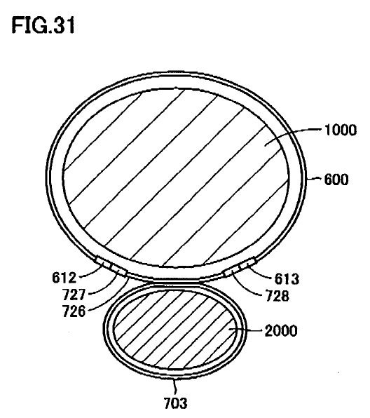

In addition, as shown in the cross-section of FIG. 31, male buckle 612 provided at the tip end portion of waist belt 601 of user wear member 500 is connected to male buckle 727 of abdomen portion belt 726 provided in abdomen portion holding member 725 of baby holding member 700. Similarly, female buckle 613 provided at the tip end portion of waist belt 601 is connected to female buckle 728 of abdomen portion belt 726 provided in abdomen portion holding member 725 of baby holding member 700.

Here, female buckle 616 and male buckle 709 as well as female buckle 617 and male buckle 708 form a vertical hold upper portion connection portion, while male buckles 612 and 727 and female buckles 613 and 728 form a vertical hold lower portion connection portion.

In addition, in order to protect the lower abdomen of baby 2000, hook member 732 attached to tip end side belt 730 provided in abdomen portion holding member 725 engages to ring-shaped member 762. Though not shown, hook member 731 attached to tip end side belt 730 also engages to ring-shaped member 761.

In vertical hold, the head side of baby 2000 is supported at two points, the side face of the abdomen thereof is supported at two points, and the crotch portion thereof is supported at one point. That is, a five-point support structure is adopted. Therefore, stable vertical hold of baby 2000 can be achieved.

Moreover, second support loop 744 supported by belt member 707 and first support loop 743 supported by belt member 706 are disposed on the side portions of the baby. Therefore, a wall by first support loop 743 and second support loop 744 is formed on the side portions of the baby, and protection of the side portions of the baby can be ensured. As a result, sway of the head is prevented, and the baby carrier with a structure implementing sufficient protection of the baby's head can be provided.

In addition, when user wear member 500 is connected to baby holding member 700, not waist belt 600 but only tip end side belt 730 provided in abdomen portion holding member 725 of baby holding member 700 is positioned in the abdomen region of the user. Therefore, mother 1000 is closer to baby 2000, and intimate contact between mother 1000 and baby 2000 can be enhanced. Consequently, baby 2000 can feel mother 1000 closer, and essential needs of baby 2000 during growing stage can be satisfied.

In addition, as baby 2000 can be held closer to mother 1000, load on mother 1000 is mitigated by bearing the load of baby 2000 in a well-balanced manner. Moreover, performance of attachment to mother 1000 is improved, without impairing safety and comfortability in holding baby 2000.

Further, a structure of waist belt 600 of user wear member 500 is simplified, and the baby carrier with higher fashionability can be provided.

Moreover, space 751H is formed by band-shaped support member 751 on the back face side of back portion holding member 740 of baby holding member 700. By inserting a hand of mother 1000 in space 751H, baby 2000 can be held in a further stable manner.

When baby 200 grows, and its neck and lower body are stable, and when keeping baby 2000 in an upright posture is not medically problematic, baby 2000 can be held in a forward-facing and vertical manner by removing back portion holding member 740 from baby holding member 700, as shown in FIG. 20.

(Back Side Vertical Hold Connection State)

Next, referring to FIG. 21, the third connection portion for enabling vertical hold of baby 2000, using baby holding member 700 on the back side of mother 1000 will be described.

In order to enable back side vertical hold connection state, female buckle 616 provided in shoulder belt 602 of user wear member 500 is connected to male buckle 708 of belt member 706. Here, belt member 706 passes through first loop region 507a provided in first shoulder belt member 505. In addition, female buckle 617 provided in shoulder belt 603 of user wear member 500 is connected to male buckle 709 of belt member 707. Here, belt member 707 passes through second loop region 508a provided in second shoulder belt 506.

In addition, male buckle 651 provided on the back face side of waist belt 601 of user wear member 500 is connected to male buckle 727 of abdomen portion belt 726 provided in abdomen portion holding member 725 of baby holding member 700. Similarly, female buckle 652 provided on the back face side of waist belt 601 is connected to female buckle 728 of abdomen portion belt 726 provided in abdomen portion holding member 725 of baby holding member 700.

Here, female buckle 616 and male buckle 708 as well as female buckle 617 and male buckle 709 form a vertical hold upper portion connection portion, while male buckles 651 and 727 and female buckles 652 and 728 form a vertical hold lower portion connection portion.

In addition, in order to protect the lower abdomen of baby 2000, hook member 732 attached to tip end side belt 730 provided in abdomen portion holding member 725 engages to ring-shaped member 762. Though not shown, hook member 731 attached to tip end side belt 730 also engages to ring-shaped member 761.

In vertical hold, the head side of baby 2000 is supported at two points, the side face of the abdomen thereof is supported at two points, and the crotch portion thereof is supported at one point. That is, a five-point support structure is adopted. Therefore, stable vertical hold of baby 2000 can be achieved.

Moreover, second support loop 744 supported by belt member 707 and first support loop 743 supported by belt member 706 are disposed on the side portions of the baby. Therefore, a wall by first support loop 743 and second support loop 744 is formed on the side portions of the baby, and protection of the side portions of the baby can be ensured. As a result, sway of the head is prevented, and the baby carrier with a structure implementing sufficient protection of the baby's head can be provided.

When baby 2000 grows, and its neck and lower body are stable, and when keeping baby 2000 in an upright posture is not medically problematic, baby 2000 can be held in a rearward-facing and vertical manner by removing back portion holding member 740 from baby holding member 700, as shown in FIG. 22.

As described above, baby carrier 1B of the present embodiment can be used in lateral hold, front side vertical hold, and back side vertical hold. Therefore, baby carrier 1B can be used from a neonatal period.

In each embodiment described above, though the male buckle and the female buckle have been used in the connection portion, those buckles are used interchangeably. In addition, a dual-type (male and female combination type) buckle can be used.

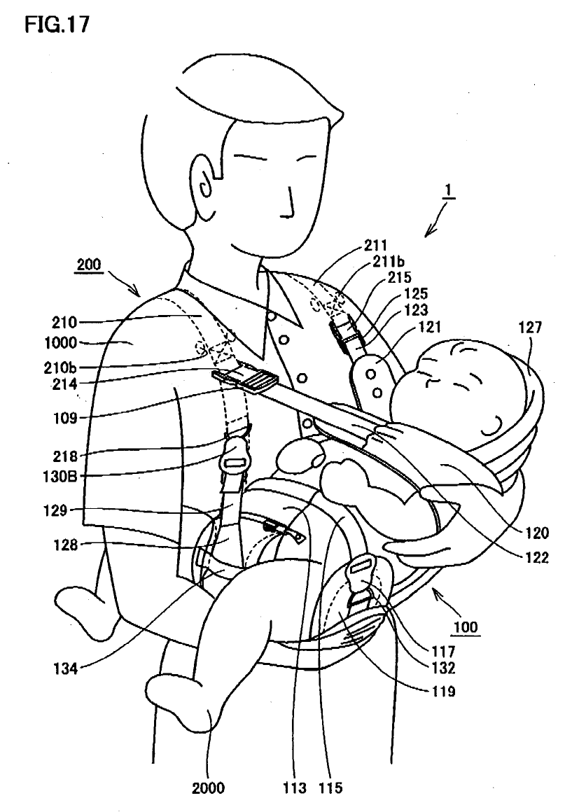

Further, though each embodiment described above has referred to a mother as a user, a father or other nursing care provider is also possible. Particularly, a father may not want to wear a baby carrier because of the appearance. On the other hand, as shown in FIG. 17, for example, a function of user wear member 200 is incorporated in a garment having an annular region for inserting an arm as well as a front and back bodice. In this manner, fashionability is enhanced, and the father will agreeably put on the baby carrier. Physical contact between the father and a child can be improved

According to the baby carrier of the present invention, the baby carrier can be adapted to a use for lateral hold, front side vertical hold, and back side vertical hold. Therefore, the baby carrier can continuously be used from a neonatal period, and physical contact between a parent and a child can sufficiently be achieved.

In addition, as a baby carrier member is implemented as a garment, the baby carrier member will be more fashionable, and can be put on in a more agreeable manner.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A baby carrier used for holding a baby by a user, comprising:
a user wear member worn by the user; and
a baby holding member for holding the baby along with said user wear member, which is detachable from said user wear member; wherein
between said user wear member and said baby holding member,
first connection means for enabling lateral hold of the baby that is laid down, using said baby holding member on a front side of the user,
second connection means for enabling front side vertical hold of the baby in an upright posture, using said baby holding member on the front side of the user, and
third connection means for enabling back side vertical hold of the baby in an upright posture, using said baby holding member on a back side of the user are provided.

2. The baby carrier according to claim 1, wherein
said user wear member includes
a user back pad member arranged on a back of the user, and
a shoulder belt provided so as to extend forward from an upper end portion of said user back pad member so that the user can wear the user back pad member.

3. The baby carrier according to claim 2, wherein
said user back pad member includes a core material.

4. The baby carrier according to claim 2, wherein
said shoulder belt is provided in a pair on left and right sides,
said baby holding portion includes a band-shaped holding member holding a head portion, an upper body portion, and a lower body portion of the baby, and
said first connection means includes
lateral hold upper portion connection means for detachably connecting vicinity areas of an upper end portion on the left and right sides of said holding member to respective one of said should belt pair, and
lateral hold lower portion connection means for detachably connecting a lower end portion of said holding member to either one of said should belt pair.

5. The baby carrier according to claim 4, wherein
a cushion member is provided on an inner face side of said lateral hold upper portion connection means.

6. The baby carrier according to claim 4, wherein
said holding member includes
a baby pad member in contact with the head portion, the upper body portion, and the lower body portion of the baby, and having a core material inside, and
a band-shaped support member provided outside said baby pad member, arranged from a head region to a lower body region of the baby, and having said lateral hold lower portion connection means provided at a lower end.

7. The baby carrier according to claim 6, wherein
a space for inserting a user's hand is provided between said baby pad member located in said upper body portion and said band-shaped support member.

8. The baby carrier according to claim 6, wherein
a band-shaped support member storage region for storing said band-shaped support member is provided on a back face side of said holding member.

9. The baby carrier according to claim 6, wherein
the core material for said baby pad member is provided so as to inwardly flex in the lower body region.

10. The baby carrier according to claim 6, wherein
a curved-face region which is inwardly cut is provided in a region where a crotch portion of the baby abuts, of said baby pad member located in said lower body portion.

11. The baby carrier according to claim 6, wherein
an additional pad member is further provided in a region where a crotch portion of the baby abuts, of said baby pad member located in said lower body portion.

12. The baby carrier according to claim 4, wherein
lowermost portion connection means for connecting to intermediate regions on left and right sides of said holding member respectively is provided in positions on left and right sides of a lowermost portion of said holding member.

13. The baby carrier according to claim 12, further comprising means for adjusting length of said lowermost portion connection means.

14. The baby carrier according to claim 2, wherein
said user wear member further includes a waist belt worn around a waist of the user,
said shoulder belt is provided in a pair on left and right sides,
said baby holding portion includes a holding member holding a head portion, an upper body portion, and a lower body portion of the baby,
said second connection means includes
front side vertical hold upper portion connection means for detachably connecting vicinity areas of an upper end portion on the left and right sides of said holding member located in a head region of the baby to respective one of said shoulder belt pair,
front side vertical hold intermediate portion connection means for detachably connecting intermediate regions on the left and right sides of said holding member located in side regions of the baby to respective one of said shoulder belt pair, and
front side vertical hold lower end portion connection means for detachably connecting a lower end portion of said holding member located in the crotch portion of the baby to said waist belt.

15. The baby carrier according to claim 14, wherein
a cushion member is provided on an inner face side of said front side vertical hold upper portion connection means.

16. The baby carrier according to claim 14, wherein
a cushion member is provided on an inner face side of said front side vertical hold intermediate portion connection means.

17. The baby carrier according to claim 14, wherein
a front side vertical hold upper portion connection means storage region for storing said front side vertical hold upper portion connection means is provided on a back face side of said holding member.

18. The baby carrier according to claim 14, wherein
a front side vertical hold intermediate portion connection means storage region for storing said front side vertical hold intermediate portion connection means is provided on a back face side of said holding member.

19. The baby carrier according to claim 14, wherein
said holding member includes a baby pad member that comes in contact with the head portion, the upper body portion, and the lower body portion of the baby, and having a core material inside.

20. The baby carrier according to claim 19, wherein
a band-shaped member is provided outside said baby pad member located in said upper body portion, and
a space for inserting said user's hand is provided by said baby pad member and said band-shaped member.

21. The baby carrier according to claim 14, wherein
lowermost portion connection means for connecting to intermediate regions on left and right sides of said holding member respectively is provided in positions on left and right sides of a lowermost portion of said holding member.

22. The baby carrier according to claim 21, further comprising means for adjusting length of said lowermost portion connection means.

23. The baby carrier according to claim 2, wherein
in said user wear member,
said shoulder belt is provided in a pair on left and right sides,
said baby holding portion includes a holding member holding a head portion, an upper body portion, and a lower body portion of the baby,
said third connection means includes
back side vertical hold upper portion connection means for detachably connecting vicinity areas of an upper end portion on the left and right sides of said holding member located in a head region of the baby to respective one of said shoulder belt pair,
back side vertical hold intermediate portion connection means for detachably connecting intermediate regions on the left and right sides of said holding member located in side regions of the baby to respective one of said shoulder belt pair, and
back side vertical hold lower end portion connection means for detachably connecting a lower end portion of said holding member located in the crotch portion of the baby to a back face side of said holding member.

24. The baby carrier according to claim 23, wherein
a cushion member is provided on an inner face side of said back side vertical hold upper portion connection means.

25. The baby carrier according to claim 23, wherein
a cushion member is provided on an inner face side of said back side vertical hold intermediate portion connection means.

26. The baby carrier according to claim 23, wherein
a back side vertical hold upper portion connection means storage region for storing said back side vertical hold upper portion connection means is provided on a back face side of said holding member.

27. The baby carrier according to claim 23, wherein
a back side vertical hold intermediate portion connection means storage region for storing said back side vertical hold intermediate portion connection means is provided on a back face side of said holding member.

28. The baby carrier according to claim 23, wherein
said holding member includes a baby pad member that comes in contact with the head portion, the upper body portion, and the lower body portion of the baby, and having a core material inside.

29. The baby carrier according to claim 28, wherein
a band-shaped member is provided outside said baby pad member located in said upper body portion, and
a space for inserting said user's hand is provided by said baby pad member and said band-shaped member.

30. The baby carrier according to claim 28, wherein
a head region, an upper body region and a lower body region of said baby pad member are separably provided.

31. The baby carrier according to claim 28, wherein
the core material for said baby pad member is provided so as to inwardly flex in the lower body region.

32. The baby carrier according to claim 28, wherein
a curved-face region which is inwardly cut is provided in a region where a crotch portion of the baby abuts, of said baby pad member located in said lower body portion.

33. The baby carrier according to claim 28, wherein
an additional pad member is further provided in a region where a crotch portion of the baby abuts, of said baby pad member located in said lower body portion.

34. The baby carrier according to claim 23, wherein
lowermost portion connection means for connecting to intermediate regions on left and right sides of said holding member respectively is provided in positions on left and right sides of a lowermost portion of said holding member.

35. The baby carrier according to claim 34, further comprising means for adjusting length of said lowermost portion connection means.

36. The baby carrier according to claim 1, wherein
said user wear member further includes a waist belt worn around a waist of the user.

37. The baby carrier according to claim 36, wherein
said waist belt includes guide means for guiding said user back pad member with respect to said waist belt in a manner allowing upward and downward movement.

38. The baby carrier according to claim 37, wherein
said guide means includes a sack portion storing a lower end region of said user back pad member so as to allow upward and downward movement of said user back pad member.

39. The baby carrier according to claim 37, wherein
connection means for connecting said user back pad member to said waist belt is provided therebetween.

40. A baby carrier member used for holding a baby by a user, comprising:
a user wear member including an annular region for inserting an arm for attachment to a shoulder portion of the user; and
a baby holding member for holding a baby along with said user wear member, which is detachable from said user wear member; wherein
between said user wear member and said baby holding member,
first connection means for enabling lateral hold of the baby that is laid down, using said baby holding member on a front side of the user,
second connection means for enabling front side vertical hold of the baby in an upright posture, using said baby holding member on the front side of the user, and
third connection means for enabling back side vertical hold of the baby in an upright posture, using said baby holding member on a back side of the user are provided.

41. The baby carrier according to claim 36, in a form of a garment including at least front bodice and back bodice.

42. A baby carrier used for holding a baby by a user, comprising:
a user wear member worn by the user; and
a baby holding member for holding the baby along with said user wear member, which is detachable from said user wear member; wherein
said user wear member includes a waist belt arranged in a waist region of the user, having a first connection member on one end, and having a second connection member detachable from said first connection member provided on another end, and
said baby holding member includes an abdomen belt arranged in an abdomen region of the baby, having a third connection member detachable from said first connection member provided on one end, and having a fourth connection member detachable from said second connection member provided on another end.

43. The baby carrier according to claim 42, wherein
said waist belt further includes a fifth connection member detachable from said third connection member, and a sixth connection member detachable from said fourth connection member in the waist region on a back side of the user.

44. The baby carrier according to claim 42, wherein
said user wear member includes a first shoulder belt and a second shoulder belt arranged on shoulders of a user,
said first shoulder belt includes a seventh connection member,
said second shoulder belt includes an eighth connection member, and
said baby holding member includes a first connection belt having a ninth connection member detachable from said seventh connection member on one end, a first support loop supporting and allowing passage of said first connection belt and positioned on a side of the baby, a second connection belt having the ninth connection member detachable from said eighth connection member on one end, and a second support loop supporting and allowing passage of said second connection belt and positioned on the side of the baby.

45. The baby carrier according to claim 44, wherein
said first shoulder belt includes a first loop region for allowing passage of said first connection belt or said second connection belt, and
said second shoulder belt includes a second loop region for allowing passage of said first connection belt or said second connection belt.
